(19) United States
(12) Patent Application Publication
(10) Pub. No.: US 2019/0228904 A1
(43) Pub. Date: Jul. 25, 2019

(54) Molded Electromagnetic Coils and Applications Thereof

(71) Applicant: Galen Suppes, Columbia, MO (US)

(72) Inventor: Galen Suppes, Columbia, MO (US)

(73) Assignee: Suppes Family Trust, Columbia, MO (US)

(21) Appl. No.: 16/240,715

(22) Filed: Jan. 5, 2019

Related U.S. Application Data
(60) Provisional application No. 62/613,851, filed on Jan. 5, 2018.
(60) Provisional application No. 62/658,129, filed on Apr. 16, 2018.
(60) Provisional application No. 62/678,147, filed on May 30, 2018.
(60) Provisional application No. 62/694,178, filed on Jul. 5, 2018.
(60) Provisional application No. 62/748,406, filed on Oct. 20, 2018.

(51) Int. Cl. H01F 27/32; H01F 27/28; H02K 3/04; H02K 3/32; H02K 15/02; H01F 41/12; B28B 1/14; C04B 35/63

(52) U.S. Cl. CPC H01F 27/327; H01F 27/2876; H02K 3/04; H02K 3/32; H02K 15/02; C04B 2235/5427; B28B 1/14; C04B 35/6303; C04B 2235/605; C04B 2235/96; H01F 41/127

(57) ABSTRACT

Molded devices are made by a molding method comprising use of magnetic fields to place magnetic particles into optimal configurations. The optimal configurations are set in place by the curing of a continuous solid-forming mixture that surrounds the particles. An example system uses urethane monomers to set iron powder mixtures into an inner and outer core of an electromagnetic coil. In addition to attractive forces to concentrate ferromagnetic particles, repulsive forces may be used to concentrate diamagnetic particles of aluminum or copper.

### CROSS REFERENCE TO RELATED APPLICATIONS

This application is a continuation-in-part of U.S. Non-Provisional application Ser. No. 15/204,345 filed Jul. 7, 2016 entitled “Terreplane Transportation System” and Ser. No. 15/808,966 filed Nov. 10, 2017 entitled “Glider Guideway System”, This application is a continuation-in-part of Provisional Application Ser. No. 62/420,456 filed Nov. 10, 2016 entitled “Terreplane Transportation System”, Ser. No. 62/432,335 filed Dec. 9, 2016 entitled “Open-Sided Coil Devices”, Ser. No. 62/527,446 filed Jun. 30, 2017 entitled “Guideway with Suspended Post”, Ser. No. 62/535,558 filed Jul. 21, 2017 entitled “Terreplane Cable, Bridge, and Tension Release”, Ser. No. 62/097,921 filed Dec. 30, 2014 entitled “Terreplane-(Transit System)”; Ser. No. 62/116,857 filed Feb. 16, 2015 entitled “Energy Saving Inventions”, Ser. No. 62/129,261 filed Mar. 6, 2015 entitled “Energy Saving Inventions”; Ser. No. 62/158,569 filed May 8, 2015 entitled “Terreplane System Plus”; Ser. No. 62/189,257 filed Jul. 7, 2015 entitled “Terreplane System Plus”; Ser. No. 62/192,490 filed Jul. 14, 2015 entitled “Terreplane System Coils”; Ser. No. 62/205,710 filed Aug. 15, 2015 entitled “Terreplane System”; and Ser. No. 62/206,358 filed Aug. 18, 2015 entitled “Energy Related Inventions”; Ser. No. 62/613,851 filed Jan. 5, 2018 entitled “Electric Motor Related Inventions”, Ser. No 62/658,129 filed Apr. 16, 2018 entitled “Tethered-Glider Related Inventions”, Ser. No. 62/678,147 filed May 30, 2018 entitled “Tethered-Glider Related Inventions”, Ser. No. 62/694,178 filed Jul. 5, 2018 entitled “Tethered-Glider Related Inventions”, and Ser. No. 62/748,406 filed Oct. 20, 2018 entitled “Electric Motor and Electromagnetic Device Related Inventions”. All of the above-listed applications are incorporated by reference in their entirety herein. All of the above-listed applications are incorporated by reference in their entirety herein.

### FIELD

The present invention relates to transportation systems. More specifically this invention relates to a ground-based transportation system with vehicles that attain aerodynamic lift and do not require a rail or road.

### BACKGROUND

This invention is on embodiments of a Terreplane Transit System (aka Terreplane). The following are characteristics of preferred embodiments: a) the vehicles are connected to an overhead propulsion carriage that propels along a stationary propulsion line, b) at least half of vehicle weight is supported by aerodynamic lift (combinations of impact momentum and Bernoulli-type lift), and c) a guideway to support vehicle weight (separate from the propulsion line) is not necessary due to the aerodynamic lift on the vehicle. Targeted travel velocities are from 90 to 500 miles per hour.

Traditional rail tracks and highways are often made of concrete or steel designed to support and guide trains or individual vehicles that ride over it. The propulsion lines (guideways) of this invention are preferably flexible rather than rigid.

The propulsion lines of the embodiments of this invention are not designed to support the weight of vehicles during normal travel. In certain embodiments the propulsion line may support the weight of a stalled vehicle; however, in supporting the weight of the stalled vehicle the propulsion line may deflect to an extent that is not suitable for the design specifications applicable to higher velocity travel. Terreplane propulsion lines are flexible, preferably where propulsion lines are cable embodiments that can sag to support weight and fully recover to a straight position when the weight is removed.

A primary benefit of the embodiments of Terreplane embodiments is that cable tensile forces are cheap compared to traditional rails or highways.

Terreplane is different than a ski lift or gondola system since the propulsion line of the Trerreplane transit system is stationary while the propulsion line of a gondola moves along the direction of travel. The vehicles of Terreplane are able to travel much faster than gondola vehicles since the propulsion line of Terreplane is a relatively straight as compared to the repeated sagging deflection of gondola propulsion lines.

The vehicles of Terreplane are different than air planes or jets because the vehicles are (preferably) pulled along a propulsion line that is indirectly attached to the ground throughout the system.

Terreplane vehicles may be of various lengths. Especially for the shorter 1 to 10 passenger vehicles, more than a third of the vehicle lift is due to momentum of air impacting the front of the vehicle and being deflected downward by downward-facing surfaces on the front of the vehicle (combined with downward moving air filling surfaces on top of the vehicle). This characteristic differentiates the embodiments of the embodiments of this invention from prior art on guideway-based flying vehicles. By maximizing the use of the vehicle front to produce lift, the total drag is minimized.

The vehicles of the embodiment can potentially experience rotation in three dimensions. By standards for aircraft the terms for these rotations are: pitch for nose up or down about a horizontal lateral; yaw as nose left or right about a vertical axis; and roll for rotation about an longitudinal axis running from nose to tail. Pitch increases as the nose moves up relative to the back of the vehicle.

A coordinate system of utility is the Cartesian coordinate system with a longitudinal axis considered horizontal and parallel to the propulsion line at the region of interest, a vertical axis, and a horizontal lateral axis perpendicular to the vertical plane. Cylindrical coordinates are also useful with a longitudinal axis considered horizontal and at the general center-line of the longitudinal body of interest, a radial distance perpendicular to the longitudinal axis, and an angular coordinate in degrees.

Wire rope is critical. It is classified by its cross section where more-robust designs are actually windings of multiple strands. For example, a 7×19 aircraft cable consists of seven 19-wire strands (smaller diameter cables) where six of these strand are wrapped around the seventh cable. An example of an oriented design is a 8×19 cable where two strands from the core which is wrapped by six of the strands; rather than round, the resulting cable would be oval in shape. The flatter surfaces of the oval cross-section define the orientation.

Connections could be installed factory-controlled settings with the cable and low-profile connections wound on reels/spools. Factory-manufactured connections would reduce standard deviations in joint properties and allow rapid installation (including replacement) of guideway cables.

### SUMMARY OF THE INVENTION

The Terreplane transit system is a land-based transportation system that incorporates wingless glider-type vehicles that primarily exert a pulling force on propulsion lines during normal operation. A complete and optimal system includes non-contact linear motor propulsion, inexpensive flexible propulsion lines based on cable strand components, novel propulsion line connection embodiments that leave most of the propulsion line circumference clear of the connector components, suspended-post embodiments that extend the maximum feasible distance between support towers, and methods to prevent the accumulation of tension forces in the propulsion lines.

In a suspension propulsion line configuration, an overhead support cable is connected to the propulsion line with vertical connection cables. The connectors of the cables may connect on the top of the propulsion line or the bottom of the propulsion line.

Connections on steel cable propulsion lines are needed for intermediate support and cable-to-cable connections. The connection preferably leave about 90% of the circumference unobstructed, which for a 38 mm diameter cable leaves 11.9 mm (38 mm×0.1×3.14) of width and unspecified lengths for these connections/supports.

Once sufficiently removed from the cable circumference (e.g. 40 mm), the 11.9 mm thickness of these connections can increase. Base case specifications allow the full dead load (e.g. 298 kg/m) to be transferred from the propulsion line to support cable. Example connections would be 3 metric ton capacity connections at 10 m spacing.

### BRIEF DESCRIPTION OF THE DRAWINGS

FIG. 1 is a illustration of a 2-dimensional coil that can be bent into an open-sided coil with two partial loops.

FIG. 2 is an illustration of an open-sided coil with two longitudinally-spaced partial loops including: a) a coil with one loop, b) a coil with two loops, and c) a coil with one loop as a stator partially encompassing a cylindrical armature.

FIG. 3 is an illustration of open-sided coils with two longitudinally-spaced partial loops including: a) a front view of a coil, b) a top view of a coil, and c) a top view of a coil as a stator partially encompassing a cylindrical armature.

FIG. 4 is an illustration of a three-phase stator of a linear induction motor incorporating three open-sided coils with a ferromagnetic sheath including: a) a top view, b) a longitudinal cross-section showing partial coils, and c) a longitudinal cross-section showing ferromagnetic teeth between coil sections.

FIG. 5 is an illustration of a twisted wire rope where: a) a sacrificial core is surrounded by seven cable strands and b) the sacrificial core is removed with placement of one strand in the center and a hanger coupling clamped around the circumference.

FIG. 6 is an illustration of a three-strand cable embodiment where: a) a sacrificial core is surrounded by three cable strands and b) a hanger is attached through use of retainers bolts with partial removal of the sacrificial core.

FIG. 7 is an illustration of an oriented cable configuration with two metal bands in the core.

FIG. 8 is an illustration of propulsion line prepared by combining tube sections of different materials.

FIG. 9 is an illustration of a method to combine tube sections of different materials.

FIG. 10 is an illustration of a circuit to transmit alternating current power with a single wire including: a) the basic circuit using a supercapacitor and b) a circuit enhanced with an RLC circuit cable of exhibiting a harmonic frequency.

FIG. 11 is an illustration of a suspended post which transmits an upward force from a lower support cable to a pair of upper propulsion lines.

FIG. 12 is an illustration of a suspended post embodiment where the support cable proceeds below a water surface and floats support part of the weight of the support cable.

FIG. 13 is a crossbar and suspended post connected at multiple points to a support cable in a configuration that allows tensile forces of propulsion lines of travel in opposite directions to reduce the accumulation of tensile forces in the propulsion lines.

FIG. 14 is an illustration an open-sided coil showing a triangle-cross-section propulsion line and dashed line for wire of a coil.

FIG. 15 is an illustration of a bent horseshoe electromagnet engaged with a propulsion line including a top view (A) and a side view (B).

FIG. 16. Stacked rotary (right) induction motor as compared to regular induction motor.

FIG. 17. Expanded view of coils of induction motor with two co-centric reactive surface tubes.

FIG. 18. Illustration of short stator engaged with armature rail as part of monorail with emphasis on illustrating electromagnets on opposite sides of monorail armature.

FIG. 19. A control joint comprised of a helical electromagnet around a longitudinal core of solid core components separated by flexible solid material.

FIG. 20. Illustration of coil with heat transfer cavity in between wires of the coil.

FIG. 21. Illustration of slant angle defined for cross section at constant longitudinal position for an aircraft at zero degrees of roll.

FIG. 22. Example wide-body fuselages design with center seating section and intermittent tensile supports connecting upper platform to lower platform.

FIG. 23. Cross section through center of rotation of one rotor of a rotating wheel embodiment.

### DESCRIPTION OF INVENTION

A Terreplane vehicle is pulled by (attached to) a propulsion carriage that runs on a line; a line often referred to as a propulsion line. Preferably, the propulsion carriage and propulsion line form a linear motor. The preferred propulsion carriage comprises a short stator that partially surrounds a propulsion line armature where a longitudinal slot allows the stator to pass by hanger connectors that support the weight of the armature. Key components of this stator are open-sided electromagnet coils.

Unless otherwise stated, electromagnetic coils include any of a variety of coil configurations for electromagnets and include an end connections for connection as part of an electrical circuit including a power supply.

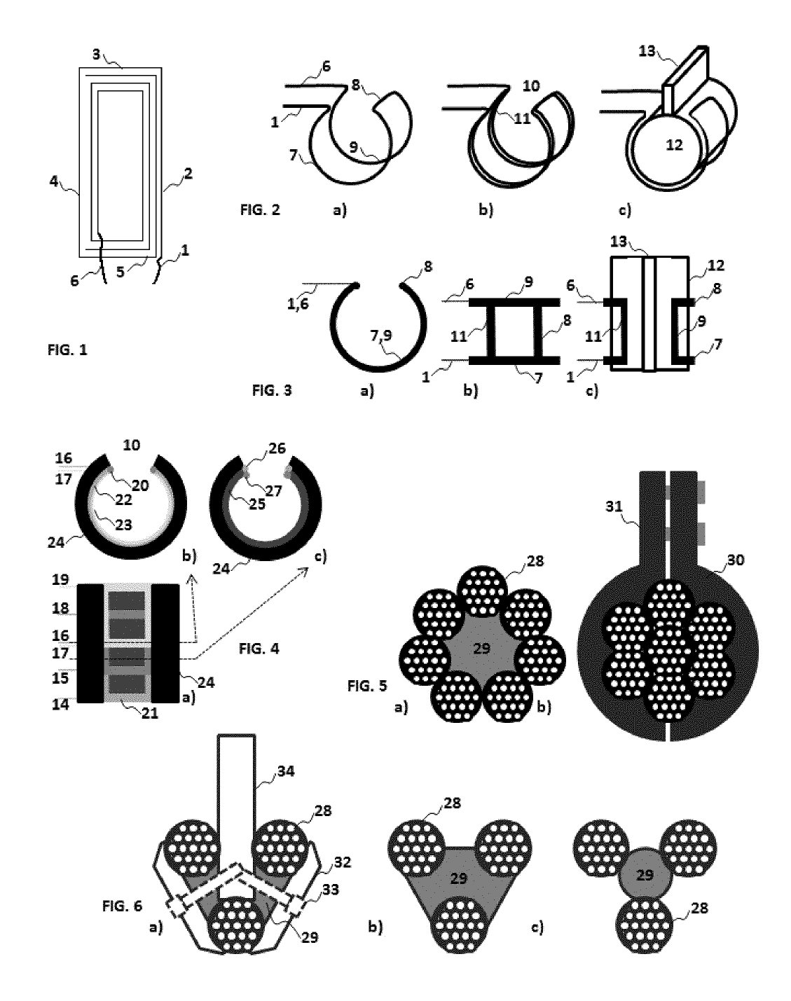

Open-Sided Coil Embodiments—An open-sided coil can be described by a method to make the open-sided coil consisting of a) winding a coil on a flat surface as illustrated by FIG. 1 comprising a connection wire 1, a first side 2, a first end 3, a second side 4, a second end 5, and a circuit-closing connection wire 6 and b) wrapping the flat coil around 55% to 95% (more preferably 70 to 80%) of the circumference of a tube such that wires of the first side 2 and second side 4 wrap around the circumference forming two sets of open-sided loops and the first end 3 and second end 5 run longitudinally along the circumference of the tube.

This FIG. 1 open-sided coil can be described as producing two magnetic coils/fields along the same cavity where the coils have opposite pole orientations. It forms a “left coil” from the wires of the second side 4 and a “right coil” from the wires of the first side 2.

FIG. 2a illustrates a single-wire coil formed by wrapping a single loop of the FIG. 1 coil around a cylinder where side 2 becomes a first partial loop 7 and end 3 becomes a longitudinal connecting wire 8 form the first partial loop 7 to a second partial loop 9. FIG. 2b illustrates how a flat coil for two loops of the FIG. 1 results in the formation of a slot 10 with the second end 5 of the flat coil becoming a longitudinal connection 11 from the second partial loop 9 to the first partial loop 7. FIG. 2c illustrates how a cylinder core or armature 12 fits in the open-sided coil allowing a connector 13 to fit through the slot 10 with free longitudinal movement of the open-sided coil along the connector 13 and armature 12. FIG. 3a in an end view of the open-sided coil of FIG. 2b, FIG. 3b is a top view of the open-sided coil of FIG. 2b, and FIG. 3c is a top view of the open-sided coil and armature 12 of FIG. 2c.

The two loops 7,9 of the FIG. 2 open-sided coil have opposite poles. Synchronizing of the distance between the two opposite-pole open-sided coils with the spacing of conductive sections in the propulsion line is critical design parameter that relates frequency of an AC voltage to a synchronized travel velocity.

The efficiency of the thrust generated from this coil will be a stronger function of velocity than that of a single coil. The slot 10 of the open-sided coil distinguishes the open-sided coil from conventional electromagnetic coils.

To a first approximation, the FIG. 3 open-sided coil will not lead to increased thicknesses of the coil windings (radial thickness relative to a longitudinal center line in the propulsion line) as can occur with other methods of making an open-sided coil.

FIG. 4a illustrates cross sections of a three-phase configuration of three open-sided coils comprising: a first connection wire for a first coil 14, a first connection wire for a second coil 15, a first connection wire for a third coil 16, a second connection wire for the first coil 17, a second connection wire for the second coil 18, and a second connection wire for the third coil 19. The FIG. 4b cross section shows the second coil connection wires 20. The first coil 21 windings 22 are under the third coil windings. A sheath 24 around the open-sided coils can improve linear motor performance. Ferromagnetic teeth 25 (FIG. 4c) can further improve performance. The preferred materials for the teeth 25 and sheath 24 is ferromagnetic. The cross section of FIG. 4b shows the longitudinal connection wires 26, 27 of the first and second open-sided coils. The three open-sided coils are preferably evenly spaced along the longitudinal sheath and operated at 120 degrees of phase between the coils.

For the configuration of FIG. 41, the first partial loop 7 is one of a plurality of first partial loops that form a first partial toroidal coil having an inner toroidal radius and an outer toroidal radius and the second partial loop 9 is one of a plurality of second partial loops that form a second partial toroidal coil having inner and outer toroidal radii equal to the inner and outer radii of the first partial toroidal coil.

Cable and Cable-Armature Embodiments—In the preferred embodiment an open-side coil short stator runs along a longitudinally-extending wire rope armature to provide propulsion. At support points along the cable armature, preferably, most of the cable armature circumference remains relatively constant with a connector obstructing only a minor part of the circumference. A sacrificial core embodiment allows cable armatures of this type to be manufactured.

FIG. 5a illustrates a wire rope of multiple strands 28 that twist around a sacrificial core 29. An example material for a sacrificial core is a thermoplastic polymer. At connection regions the core 29 can be partially or totally removed. When removing the core, one or more of the strands may be positioned in the center. With the sacrificial core removed, the resulting cable has a reduced diameter. A connector 30 may be placed around this reduced-diameter section to produce an overall diameter similar to the cable prior to removal of the sacrificial core 29. The neck 31 of the clamp is a narrow section attaching the cylindrical clamp section to structural parts (not shown) of the clamp for fastening the clamps to supports. The neck width (horizontal distance of FIG. 5 and FIG. 6) is a critical design feature that impacts the design of carriages that travel along the wire rope.

Sacrificial Core Cables A 6×19 poly core cable has a similar appearance as a 7×19 cable where the former has a polymer core (e.g. polypropylene). Inner materials such as thermoplastic polymer foams could be light-weight sacrificial fillers in these cables. For example, a 50 mm cable with a 32 mm thermoplastic polymer foam core would have a similar tensile strength as a 38 mm cable without polymer foam filler. Heat and force can be applied to the 50 mm cable to reduce the diameter by squeezing out gases and/or the melted polymer from the foam core resulting in a lower diameter cable to which traditional clamps can be applied.

FIG. 6a illustrates an alternative sacrificial core configuration where the three strands 28 are in a triangular configuration comprising a first strand, second strand, and third strand; where a first retainer bracket 32 presses (for example, with a bolt 32) the second strand against a hanger 34 connector where the hanger connector 34 is inserted between the first strand and the second strand, the first retainer bracket presses the third strand against a second retainer bracket, the first retainer bracket is secured to the hanger connector at a region between the second strand and the third strand, the second retainer bracket presses the first strand against the hanger connector, the second retainer bracket presses the third strand against the first retainer bracket, the second retainer bracket is secured to the hanger connector at a region between the first strand and the third strand, and a plurality of longitudinally-aligned hanger connectors connect to the wire rope propulsion line.

In a more-generic description, a wire rope guideway 51 is comprised of a plurality of longitudinally extended strands 28, at least one longitudinally extended flexible strip 29, and a plurality of longitudinally aligned connectors 30; comprising a radial coordinate dimension in a plane perpendicular to the longitudinal direction of the armature and extending from the geometric center of the wire rope guideway, where: the strands 28 at least partially surround the flexible strip 29 forming a wire rope with a constant circumference where the circumference contacts and is contained within a maximum wire rope radius, the flexible strip 29 comprising a compressive strength resisting radially inward forces where at least part of flexible strip is removed at regions where connectors are attached, the connectors 30 connected to and support the wire rope guideway, connector assemblies (comprising the connectors, strands 29, and any items used in attaching the connectors to the wire rope), parts of the flexible strip 29 are removed to create volumes for attaching the connectors 30, and at regions where connectors connect to the wire rope at least seventy percent (70%) of connector is contained in a continuous circumference within the maximum wire rope radius.

The sacrificial core 29 may be molded to conform to a close fit to the strands (FIG. 6b), may be substantially cylindrical (FIG. 6c), or any of a rage of geometries that provide a needed resistance to radial compressive forces needed for propulsion.

At the end of cable sections, sections of sacrificial core could be removed and bonding methods performed on the exposed inner surfaces to attach to cable-to-cable connectors. At cable ends and with removal of the core, the load-bearing strands could be wound differently and specifically for good connections to factory-installed end-to-end connectors—all preserving good outer diameter specs and without obstruction of 90% of the circumference.

Factory-installed connections to the cables would enhance quality and literally allow a mile of propulsion line to be rolled from a reel, ready to clip onto support structures. The upgrading of large sections of propulsion line could be performed overnight with easy recovery and recycle of the old propulsion line.

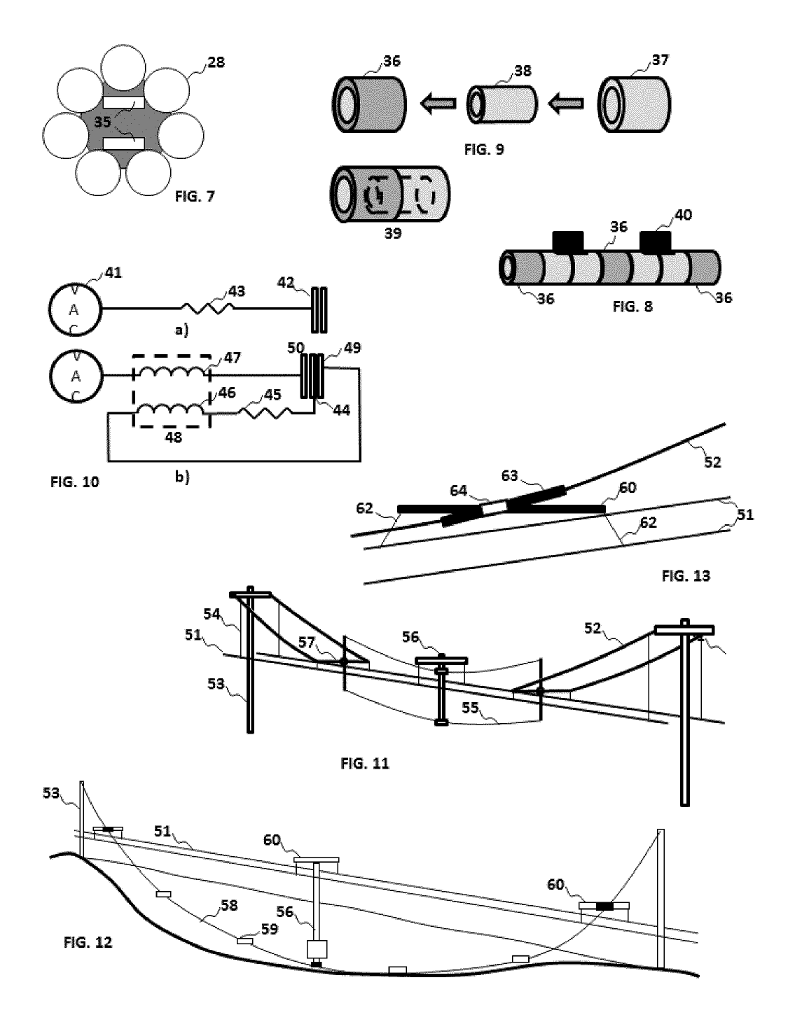

Steel tape 35 (see FIG. 7) can be used as the core material. Use of two face-to-face metal tapes in the core of the cable could cause the cable to arch (e.g. arch upward) if the length of one of the metal tapes is slightly more than the other. An elastic polymer layer between the two metal strips would provide a place for systematic bending of the longer metal tape if a tension is applied causing the natural arch to allow reversible straighten of the cable. The force creating the arch could be oriented to counter the weight of the cable. In this approach, the 3 mm drop in cable that occurs over 6 meters at 10% of nominal tension could be eliminated. For example, connection points could be spaced at 20 to 50 meters while meeting the 3 mm drop specification. Sequential (end-to-end) arching of the steel tape in a polymer core, where a polymer foam core elastically/reversibly preserves the arch is a preferred configuration in this embodiment.

The wire rope may be made of materials other than wire, especially if a carriage with wheels runs along the wire rope instead of a short stator. Cables (or wire rope) are suitable for use with wheel-based propulsion which has a demonstrated performance history with aerial trams. Preferred to wheel-based propulsion is the use of linear motors where electromagnets on the propulsion carriage would wrap around reactive elements in the cable. The reactive elements in the cable would be an outer conductive layer such as strands (or a shell) of copper or aluminum. Repulsive force induced in the copper/aluminum would provide forces for propulsion (longitudinal force) as well as a radial-force (levitation) around the propulsion line cable (i.e. a magnetic bearing).

As part of a linear motor, the propulsion line 51 is optionally comprised of longitudinally discontinuous sections of ferromagnetic material. As the open-sided coil approaches (or partially surrounds) a section of ferromagnetic material (of similar cross-section as the cavity in coil) the magnetic forces pull the material into the coil. As the coil approaches a ferromagnetic section of the propulsion line, the current in the coil causes a magnetic field to pull the ferromagnetic material toward the longitudinal center of the coil creating a pulling force on the propulsion line 51. To prevent a “braking” force, the current in the coil is terminated before the ferromagnetic section reaches the center of the coil.

The most preferred use of the open-sided coil is in a linear induction motor where electromagnets are operated at an alternating frequency generally above 50 Hz and typically from 200 to 900 Hz. The most-preferred cable armature has an outer layer of a conductive material like aluminum and an inner layer of ferromagnetic material like ferromagnetic steel. The layering may be layers of wires, layers of strands, or coatings. The preferred thickness of the aluminum layer is between about 0.08 and 0.2 inches.

The FIG. 6 wire rope propulsion line sacrificial core 29 may be a flexible strip that is an insulator to electron flow and at least one of the strands 29 is connected to a voltage source. This configuration preferably uses straight strands along the armature as opposed to twisting strands. The configuration requires the use of retainers 32 and hanger 34 of materials resistant to conducting electricity.

The most-preferred embodiments transmit electrical power in the strands of a cable armature, and this is transferred to the propulsion carriage using sliding or rotating electrical contacts. In flight, the carriage is not grounded, and so, conventional technology dictates that a minimum of two conducting wires and two sliding/rotating contacts are needed.

FIG. 10 is an embodiment that transfers alternating current with a single wire. Sliding/rotating contacts connect with a VAC source 41 connecting the source to a plate of a capacitor 42 (a plate is a conductive area in a capacitor performing as a large surface area but is not necessarily of a plate geometry) which is able to give up and take electrons based on the plates 42 charge state. This small current may power a load 43. At 60 Hz, the efficiency increases as frequency increases.

The effectiveness of a single-wire transfer can be increased when the transfer is coupled with a circuit that is out of phase with the VAC source 41, preferably 180 degrees out of phase. An example circuit that can operate in a harmonic mode is comprised of a second capacitor plate 44 coupled with a load 45, coil 46 that is optionally coupled with a coil 47 in line with the VAC source 41, and a third capacitor plate 49 that is coupled with the second capacitor plate 44. The load may be an armature coupled with one or both of the coils 46,47 rather than a specific resistor in the circuit.

An alternative hybrid propulsion line embodiment has both sections of ferromagnetic (or magnetic) and conductive (non-ferromagnetic) material. The ferromagnetic sections are used to provide attractive propulsion force while the conductive sections are used to provide strong repulsive forces between the inner partial coil on the carriage and the propulsion line 51. The propulsion carriage (for use with hybrid propulsion line) contains multiple open-slot electromagnets to provide the ability to pull toward ferromagnetic (or magnetic) sections of the propulsion line or to repel way from conductive sections of the propulsion line. The strongest attraction-based propulsion uses ferromagnetic or magnetic (hereafter F/M) sections of length about equal to the length of the electromagnet with spacing between F/M sections about equal to the length of the magnet. The open-sided coil magnet turns on when the center of the open-sided coil is about half way between F/M sections and turns off when in the middle of a F/M section. Conductive sections of the propulsion line may be arranged to allow alternating current to be applied to carriage's open-sided coil to provide levitation without propulsion. Also, the addition of a conductive section between the F/M sections adds to the force forward.

Suspended-Post Embodiment—In some embodiments it is preferred to use a support cable that that dips/sags between posts (like the structural cable of a suspension bridge) where the propulsion line 51 is connected to the support cable 52 in a manner that maintains a relatively straight propulsion line.

FIG. 11 illustrates an embodiment where the support cable 52 sags below the propulsion lines 51. One or more support cables 52 are supported at the top of the towers 53 as in a standard suspension propulsion line (suspension guideway) embodiment. The support cable 52 connects to a merging coupling 57 that keeps the space support cables 52 as the pair contacts the coupling 57. Emerging from the coupling 57 a first converged cable 55 and optional second converged cable continue in a longitudinal path that does not intersect the vehicle travel paths(e.g. a path aligned with the support towers). This lower support cable(s) 55 supports the load of a suspended tower 56 with a cross bar 60 that extends over the vehicle travel path. Connectors connect crossbar 60 to the propulsion lines 51, and a bracket connects the suspended post 56 to the support to the support cable 55 at a region below the propulsion lines. This embodiment allows the use of shorter towers 53.

The converged cables 55 may be of different lengths between the couplings 57. The suspended tower 56 and/or crossbar 60 may be anchored to the ground with cables to reduce movement.

Each of the converged cables 55 may be a continuation of one of the upper pair to support cables 52 where the coupling 57 guides and spaces the cables. Alternatively, cables may clamp onto the coupling 57 and end at the coupling.

Preferably, when the support cables 52 are above the propulsion line, vertical connection cables 54 connect the support cable to the propulsion line. When the support cables 55 are below the propulsion line the weight of the propulsion line is indirectly supported by the support cable 55 through connection cables that connect the propulsion line to the crossbar 60 of the suspended tower 56.

For bridges over water, the support cables 58 may extend below the water surface (see FIG. 12). Under the water surface, buoyant material (e.g. floats) 59 may be attached to the cable to support at least some of the weight of the cable. In this configuration, the submerged support cable may extend for considerable distances (miles) since the weight of the cable is a primary factor that limits the spacing of towers 53. This approach can be used to build bridges over expanses of several miles across water. The submerged cables could be put in trenches of floor bottom dirt in shallow water as a means to protect against being hit by objects in the water. Floats may be attached to suspended towers to facilitate keeping the towers vertical and to provide for additional buoyancy to support temporary weight of stalled vehicles.

As an alternative to forming a tower and crossbar that form a “T” shape, the crossbar may be at the top of a quadrangle that is outside the vehicle travel paths where the bottom of the quadrangle is connected to one or more support cables 55.

Alternative to a converged cable 55 going between vehicle paths, the support cables 52 can be diverged (further apart) to go on the outside of the vehicle paths and support suspended quadrangle supports with cross bars 60.

In a more-generic suspended post embodiment of a transportation system comprises: a pair of horizontally-aligned cable propulsion lines of opposite travel direction along a longitudinal route, a support cable along a vertical plane where vertical plane is parallel to the cable propulsion lines, a horizontal crossbar perpendicular to the vertical plane and connected to the pair of cable propulsion lines by a pair of connectors, and a suspended post that is connected to the horizontal crossbar and support cable. The crossbar supports a portion of the weight of the cable propulsion lines, the suspended post supports the weight of the crossbar and the portion of the weight of the cable propulsion lines, and the support cable supports the weight of the suspended post, the weight of the crossbar, and the portion of the weight of the cable propulsion lines.

Preferred when the support cable 52 sags below the cable propulsion lines 51 is a configuration where the suspended post 56 connects to the support cable 55 at a region below the cable propulsion lines 51, and the suspended post 56 is vertical.

Preferred when the support cable 52 is in close vertical proximity to the transportation line 51 is the suspended post of FIG. 13 where the suspended post extends along the support cable 63 for a distance greater than one fifth the length of the crossbar 60 and is attached to the support cable 63 at multiple regions. Here two vehicle carriages of opposite travel directions exert two tensile forces of opposite directions on the cable propulsion lines, at least part of the tensile forces are transferred to the crossbar by the connectors forming torque forces of oppose direction, the torque forces are transferred from the crossbar to the suspended post, and the torque forces are transferred from the suspended post to the support cable forming tensile forces on the cable.

The most preferred application for the FIG. 13 embodiment is if/where a single support cable attains a minimum position (thus being horizontal) right above and between a pair of transportation lines.

In the absence of the transfer of tension that occurs with the FIG. 13 embodiment, the propulsion forces of consecutive vehicles on a single transportation line would be cumulative and eventually pull the transportation line apart or away from connectors. An alternative embodiment for releasing tension from a transportation line is where a diagonal line connects the transportation line to the support cable 66 where the diagonal line goes upward in the direction of travel. In this embodiment a vehicle 67 is pulled by a carriage 68 that places a tensile force on the diagonal line. The lower the angle of the diagonal line from the transportation line the more effective the transfer of tensile forces from the transportation line 51.

An embodiment to keep the propulsion line from sagging (keep it straight) between connections to the main support cable 52 is where a second tier support cable 69 and connection cables 70 are used. One implementation of this embodiment is to attach second tier support cables 69 to connection cables 70 that are connected to either the primary support cables 52 or crossbars 60. Second tier connection cables 70 connect the second tier support cable 69 to the propulsion line 51.

Hangers 71 may attach on the bottom sides of the transportation line. A cable or steel band 72 between the hangers 71 supports spacers 73 that transfer tensile force of the band 72 to an upward force on the support.

For the based case 3 mm drop specification, the 6 meter distance between vertical connection cables can be doubled with the use of tension bands at about 10% of the nominal tensile load of a 38 mm steel wire rope. The band and middle support preferably support half the cable weight for this expanse, which is about 37 kg. If the connection cables and hangers are to support half of the load specifications on the cable, each must support about 3.6 metric tons. This load is half the nominal tensile strength of a 10 mm steel cable.

Vertical Force Analysis—Lift forces are exerted on vehicle 67 embodiments. The preferred modes of providing lift are momentum impacting the bottom of the vehicle 67 and low pressure forming on the back part of the top of the vehicle. Here, bottom sloping surfaces 74 that slope from the vehicle nose to the support of the vehicle's interior are a most important that air impacts to create aerodynamic lift.

To promote a passenger compartment of constant cross-section, it is preferred that lift forces focus on the front and back of the vehicle in a manner that leads to zero torque. Flaps 75 on the front (see vehicle nose) and the back of the vehicle allow for fine adjustment of lift with velocity and control of vehicle in response to disturbances such as wind or passenger movement. Similar lift features can be implemented on the propulsion carriage 78 so as to lead to near-zero vertical forces between the propulsion carriage 78 and propulsion line 51.

Longitudinal Force Analysis—It is preferred to have the vehicle 67 travel as close to the propulsion carriage 78 as possible to minimize torque due to longitudinal forces. It is preferred to have the propulsion carriage longitudinally centered on the top of a symmetric vehicle to promote lateral stability.

Torques balance (torques in a vertical plane parallel to the propulsion line) in steady-state flight, including with the use of an improved connector arm. An improved connector arm system embodiment has the advantage of a design where near-zero vertical force between the propulsion carriage 78 and the propulsion line 51 is more-easily attainable during flight; however, it can be attained with a single arm.

In this improved connector-arm embodiment, a hinge joint connects the front end of the connection arm 79 to the propulsion carriage by a hinge joint 80. The other end of the connection arm 79 is connected to a vertically-extended vehicle arm connection 76 (hereafter VEAC) by a hinge joint 77. Preferably, during normal flight the propulsion line 51, forward arm hinge joint 80, and back arm hinge joint 77 are in (or nearly in) the same plane.

The hinge joints 80 77 allow the vehicle 67 to swing up to fly or down to load/unload.

The force vectors can be described around a base case example during preferred normal flight of the vehicle 67. Key aspects of these base case force vectors are: a) a pulling force vector on the VEAC joint(s) 77 with a cumulative vector superimposed on the propulsion line, b) an air momentum impact vector that pushes back and up on the vehicle 67 on a bottom surface 74, and c) a gravitational force vector through the center of gravity of the vehicle 67. In this base case configuration, the only upward force is on front surfaces of the vehicle. In practice designs allow for more surfaces to be effectively used.

Also, for a torque balance on the base case force analysis; the line of rotation may be the line through the VEAC joint(s) 77. Since the pulling force goes through the line of vehicle rotation, the pulling force of the arms 79 does not produce torque. Preferably the VEAC joint(s) 77 are a single joint, and most-preferably, rather than two hinge joints it is a single hinge joint with a single arm and a single SMPCAH joint 80 on the same side of the propulsion line.

The VEAC joint(s) 77 are located, longitudinally, in front of the center of gravity, and so, gravitational force produces a clockwise torque. The air momentum impact force has a net vector below the VEAC joint(s) 77, and so, the air momentum impact force creates a counter-clockwise torque that balances the torque resulting from gravity. Herein, the preferred embodiment is defined using methods known in the science to create zero net torque about the VEAC joint(s). This base case illustrates how air impact momentum at the front of the vehicle can be transformed to a lifting force for the entire vehicle.

Preferably, SMPCAH 80 are located toward the front of the propulsion carriage 78. Preferably, VEAC are attached to the top of the vehicle and toward the front of the vehicle 67.

In this base case design, there is a velocity specific to a vehicle (surface, weight, and center of gravity) that leads to a horizontal pitch for the preferred flight having near-zero vertical force between the propulsion carriage and the propulsion line. Likewise, there are a range of pitches (pitch of vehicle relative to propulsion line) for which each pitch has a single velocity that leads to near-zero vertical forces on the propulsion line.

Optionally, allow movement of the VEAC joint(s) 77 along this longitudinal dimension of the vehicle to balance torque on the vehicle. The angle of the VEAC joint(s) is preferably controlled to control vehicle pitch.

Switching—A method for a propulsion carriage to switch from a travel guideway to a switch guideway at a switch region where, in the preferred embodiment, the switch guideway is located above the travel guideway. Each guideway has a cross section perpendicular to the travel route. Each cross section has vertical region (point or line of distance) of maximum horizontal width. The surface of the guideway above the vertical region of maximum horizontal width is the upper surface of the guideway and the surface of the guideway below the vertical region of maximum width the lower surface of the guideway.

As the propulsion carriage travels along the route on the travel guideway, at the switch region the entry end of the switch guideway physically is the point where the switch guideway starts (along the route dimension). Starting at the end, the switch guideway's route (starting at the entry end) is approximately parallel to the travel guideway route over a longitudinal distance at the switch region. After the switch region, the path of the switch guideway departs from the path of the travel guideway.

The switch-capable propulsion carriage is comprised of an upper switch guideway engagement mechanism and lower travel guideway engagement mechanism which are capable of engaging the switch guideway and the travel guideway, respectively. The propulsion carriage achieves a switch by engaging the switch engagement mechanism with the switch guideway.

A preferred upper switch engagement mechanism is comprised of a suspension means of interaction such as at least one pair of wheels or pair of electromagnet ends. The propulsion carriage performs the switch maneuver when the upper switch engagement mechanism travels above the upper surface of the switch guideway at the start of the switch guideway. In this switch maneuver, the upper switch engagement mechanisms engage the switch guideway and takes the carriage along the route of the switch guideway. For example, the pair of wheels are above the upper surface of the switch guideway and roll/run on that upper surface.

Alternatively, when the upper switch engagement mechanisms are below the lower surface of the switch guideway, the propulsion carriage fails to engage the switch guideway and travel proceeds along the (default) travel guideway. For example, the upper pair of wheels of the propulsion carriage are below the lower surface of the switch guideway and do not engage (roll on) any surface.

A controlled engaging of the switch guideway is achieved by controlling the distance between the upper switch engagement mechanism and the upper surface of the travel guideway which can be achieved by either a) locating/moving the lower travel engagement mechanism further above the upper surface of the lower guideway orb) increasing the distance between the upper switch engagement mechanism and the lower travel engagement mechanism on the propulsion carriage.

Moving the entire carriage further above the lower guideway (travel guideway) can be achieved by moving the wheels of the lower engagement mechanism lower. Alternatively, a travel guideway may have a narrower upper extension and a wider lower part. By engaging the upper extension section the propulsion carriage travels higher while by engaging the lower wider section the propulsion carriage travels lower.

A propulsion carriage may be two propulsion carriages (one on top of the other) connected by at least two arms of equal length at different longitudinal regions such that the arms pivot at joints of attachment to the two carriages. The maximum separation distance is when the arms are perpendicular to the surfaces of attachment.

The switch guideway is preferably above the travel guideway.

One or more arms attach the propulsion carriage to a vehicle. Preferably, if the switch guideway veers to the right of the travel guideway, the arm is connected to the right side (right of path of guideway through propulsion line right of center of gravity) of both the propulsion carriage and the vehicle. (and visa versa).

Preferably, a connection joint on the propulsion carriage is in the same horizontal plane as the propulsion line which the propulsion carriage engages. A connection joint on the vehicle is preferably at a region that can be in the same plane as the propulsion line during normal travel; such a region is above the passenger compartment and most-easily positions as an extension above the passenger compartment.

Joints that are horizontal and perpendicular to the propulsion line allow a continuous arm and joint to keep the vehicle horizontal by positioning the center of gravity below the propulsion line. Preferred joints are hinge joints.

Hinge joints have multiple points of contact along a pin or pins. The points may be on the same or opposite sides of the cavity for propulsion line travel. If on opposite sides of the cavity, a lateral arm may connect the two sides in a manner where rotation of that lateral arm (as corresponding to vehicle movement) does not cross the line of travel of the propulsion line during travel or during switching.

As a safety precaution, when the propulsion carriage travels above the guideway, the wheels and/or casing of the propulsion carriage form a gap below the guideway wider than the support bars but narrower than the widest part of the guideway. This physically prevents derailment. The same analogy applies above the guideway for a propulsion carriage traveling below an upper guideway.

For a switch to occur, either the casing/wheels must widen or the travel guideway must become more narrow. Both are viable options. If the guideway becomes more narrow, the region proximity of the upper guideway to the lower guideway guards against derailment. Alternatively, the widening of the casing/wheels can be physically coupled with the mechanism to engage the upper guideway.

Both the switch and travel guideways may have a narrow configuration at switching regions thus allowing the engaging of the switch guideway to occur by either travel over the entrance end or travel up past the narrow section.

Optionally, the force needed to keep the propulsion carriage 78 in contact with the propulsion line 51 during this switch can be achieved with aerodynamic forced induced by the flaps on the propulsion carriage.

A method of switching is where the propulsion line cable is part of a propulsion line 51 for a short stator embodiment is represented by the same image as the propulsion line electromagnet for the long stator embodiment. Likewise, an open-sided propulsion carriage tube is illustrated for the long stator embodiment by the same depiction as the open-sided propulsion carriage electromagnet for the short stator embodiment.

In the long stator embodiment, two open-sided propulsion carriage tubes (reactive components) are connected and positioned between two series of propulsion line electromagnets (active components, e.g. electromagnets). At switching regions two series of propulsion line electromagnets” allow for interaction with either of the two open-sided propulsion carriage tubes. The two series of propulsion line electromagnets proceed to different paths in the switch maneuver where the path taken by the propulsion carriage is the switch line.

The preferred method for the switch proceeds to following the switch line in the following sequence: a) only the electromagnets on the switch line are activated (or are activated to a much greater extent than the other line) and b) the open-sided propulsion carriage tube is tightened around the switch line and widened around the opposite line to allow the carriage to be disengaged and separate from the opposite line.

In a short stator embodiment, the open-sided propulsion carriage electromagnet has a slot capable of mechanically widening or narrowing to engage (or disengage) a propulsion line cable to perform a switch. The short-stator switching sequence includes: a) only the open-sided propulsion carriage electromagnet s around the switch active are activated (or are activated to a much greater extent than the other line) and b) the open-sided propulsion carriage electromagnet is tightened around the switch line and widened around the opposite line to allow the carriage to be disengaged and separate from the opposite (non-switch) line.

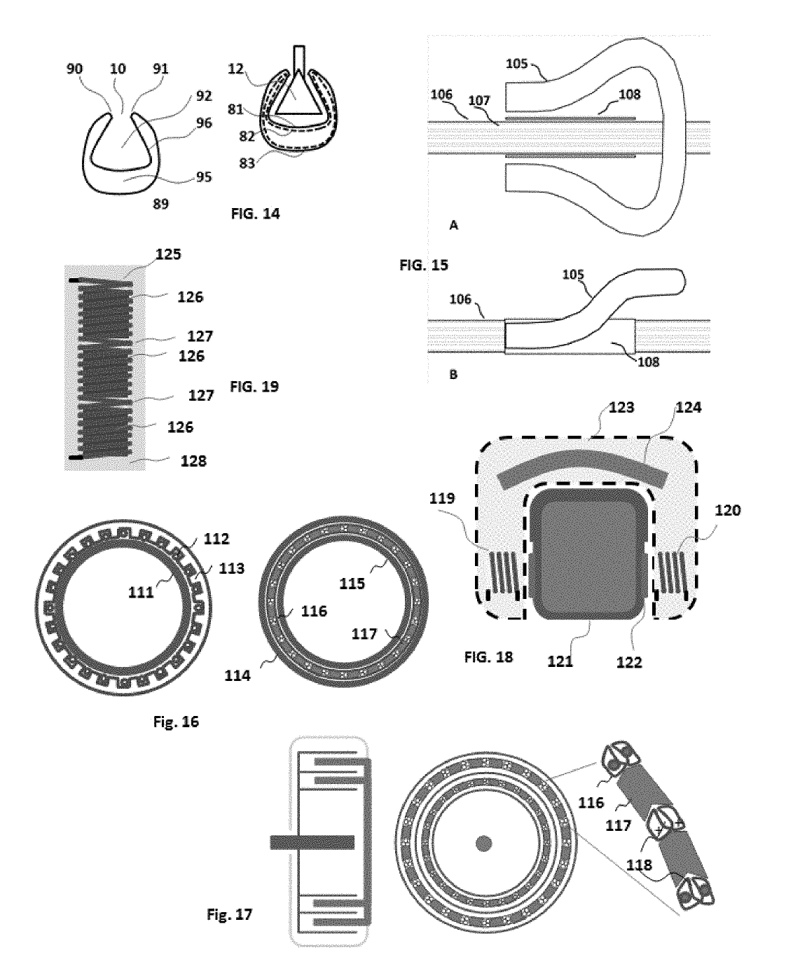

Generic Open-Sided Coil—FIG. 14 is an end-view of an open-sided coil in the short stator of a propulsion carriage. The inner surface 40 of the tube 38 has a shape such that when the carriage 78 is placed over the propulsion line 51, there is a relatively uniform space between the tube's inside surface 40 of the coil's 37 out surface as illustrated by FIG. 14.

In the general sense, a mold that preserves the shape of a magnetic coil, core, cavity, and slot may be a thermoset polymer that holds the components in place or may be any of a range of mechanical constraints that serves the same purpose. In the general sense, the cavity forms a shell 81 through which an insert 12 passes and the slot forms a path through with connections to the insert pass. More specifically for the embodiments of this invention, the shell 81 and insert 12 engage to form a linear motor. An example of a shell 81 is an open-sided reactive tube 38, and an example of an insert 12 is a propulsion line 51. The shell 81 component of the linear motor may be either on the carriage 78 or the propulsion line 51; and likewise, the insert 12 component may be either on the carriage 78 or the propulsion line 51.

For specification purposes, the cross section of the insert 12 has a geometric center with a reference longitudinal axis extending along said geometric center; relative to said center axis as a coordinate, positions may be defined by a radial dimension from said axis and angle (in degrees or radians) clockwise from vertical. The open-sided coil is comprised of multiple loops (sequence of rings) of wire where each loop is bent around the insert at from 100 to 170 degrees (in addition to the curvature to form spiral rings). More preferably, the angular coordinate extends from 120 to 155 degrees. FIG. 14 illustrates a coils extending about 165 degrees around the insert 12.

Alternative to widening the slot of the lower tube 88 when the propulsion carriage disengages from the lower line, the width of the lower propulsion line may be reduced adequately to allow the carriage to slip up and away from the lower propulsion line. In this embodiment, the propulsion carriage is preferably designed so the two propulsion lines provide obstruction to derailment by not allowing sufficient vertical movement unless the switch is in progress.

While the previous paragraphs use descriptions in terms of upper and lower propulsion lines, the switch can be oriented with horizontal or vertical (or any angle in between) movement to select and engage with a switch propulsion line.

The most preferred configuration for as switch is with a vehicle having a single arm with a hinge joint connection to the propulsion carriage on the side of the carriage opposite the joist 84 used to support and separate the two propulsion lines used during the switch operation. The arm preferably has a hinge joint in a common plane with the propulsion line when the carriage engages that lower propulsion line. Also preferred is a hinge joint connection 77 at the upper arm connection point of certain vehicle representations.

Linear Motor Propulsion—An alternative open sided coil embodiment is created by flattening a coil of wire and wrapping that flatten coil around a cylinder. FIG. 14 illustrates the resulting open-sided coil with an inner surface 81, an inner partial coil 82, an outer partial coil 83, a cavity, and a slot 10. Longitudinally displacing the outer partial coil 83 from the inner coil 82 produces the open-sided coil of FIG. 2.

The open-sided coil is capable of traveling along or attaching to a propulsion line 51 that has a cross-section that fits within the cavity as illustrated by FIG. 2c. The slot 10 allows connection of the propulsion line to a support structure (e.g. suspension cable). Optionally, the slot allows attachment of the open-sided coil to a propulsion line to form a long stator. The embodiment is not limited to any particular orientation; the slot may be to the side, bottom, or any angle.

The surroundings to a coil are all that is outside the coil, the slot, the two ends of the coil, and a protective surface that encases the open-sided coil for protection and structural needs.

In a broader sense the preferred linear motor comprises an open-sided coil stator that travels along a longitudinally-extending armature of constant circumference comprising: a plurality of longitudinally-aligned armature connectors supporting the weight of the armature, a radial coordinate dimension in a plane perpendicular to the longitudinal direction of the armature with an origin at the geometric center of the armature and an angle having a value of zero for a radially-extending line going through geometric center of the armature connectors, a width dimension equal to the width in a plane perpendicular to the longitudinal direction of the armature and perpendicular to the radially-extending line going through the geometric center of the armature, a plurality of connector necks extending radially outward where said necks have similar neck widths, a maximum armature width that is greater than the said neck widths, a stator cavity extending the longitudinal length of the stator surrounding the armature circumference comprising an inner cavity surface 81 adjacent to the armature circumference, a longitudinally extending stator slot along the cavity where said slot is wider than the said neck widths and narrower than the maximum armature width, and an open-sided electromagnet coil configuration in the stator where at least half the coil is adjacent to the inner cavity surface 81 and extends at least 180 degrees along that cavity wall, where the connector necks pass through the slot as the stator travels along the armature.

Molded Self-Assembled Embodiments

Linear Motor Propulsion—Preferably, Terreplane uses an open-sided coil 89 as part of linear motor for propulsion (for acceleration). A first description of the open-sided coil 89 embodiment is in terms of an illustrative means of fabrication where a flat rectangular core is wrapped in wire to form a coil around the flat core. The end view of the flat core encased in the coil has a left side 90 and right side 91. An open-sided coil 89 is formed by wrapping (folding) the flat core and coil around an object (e.g. a rod) such that the left side 90 and right side 91 approach each other to form a slot 10 between the left and right sides. The open-sided coil 89 is open on both ends and the slot 10 provides access to the cavity 92 as illustrated by FIG. 14. This can be referred to as folding the core and coil to create an inner partial coil 93, an outer partial coil 94, a cavity 92, and a slot 10; cumulatively they form the open-sided coil 89.

The open-sided coil is capable of traveling along a propulsion line 2 that has a cross-section that fits within the cavity 92. The slot 10 allows connection of the propulsion line to a support structure (e.g. suspension cable). The embodiment is not limited to any particular orientation; the slot may be to the side, bottom, or any angle.

In a more-general open-sided coil embodiment, the core 95 is not limited to a flat geometry. The core 95 has two primary purposes in addition to the prospect for simplifying the manufacturing process. First, the core 95 provides a space between the top and bottom parts of the coil in a manner and of a material such that the current in the outer coil is not cancelled by the current of the inner coil for purposes of creating a magnetic field. For example, the core 95 could be comprised of ferromagnetic wires encased in a thermoplastic to create flexibility. Second, the core 95 creates the spacing between the inner and outer coils that can impact the shape of the cavity created when “folded” to create the inner partial coil 94, cavity 92, and slot 10.

Once folded, the open-sided coil 89 may be molded (or locked) into the folded position by methods known in the art. Alternatively, the folding process may be reversible through the use of clamping arms that push the left side 90 and right side 91 together. The reversible embodiment has utility for applications where the open-sided coil 89 is part of a propulsion carriage 5 that wraps around a propulsion line 2 in a manner that will not allow it to slip off the propulsion line 2.

As part of a linear motor, the propulsion line 2 is optionally comprised of longitudinally discontinuous sections of ferromagnetic material. As the open-sided coil 89 approaches (or partially surrounds) a section of ferromagnetic material (of similar cross-section as the cavity in coil) the magnetic forces pull the material into the coil 89. As the coil 89 approaches a ferromagnetic section of the propulsion line, the current in the coil 89 causes a magnetic field to pull the ferromagnetic material toward the longitudinal center of the coil 89 creating a pulling force on the propulsion line 2. To prevent a “braking” force, the current in the coil 89 is terminated before the ferromagnetic section reaches the center of the coil.

The open-sided coil 89 is an electromagnet comprised of a continuous electrically conductive wire adjacent to and wrapped around a core 95. The open-sided coils is comprised of the following: a longitudinal core 95 length dimension extending between the poles of the electromagnet, a core width and core thickness such that the width has a first side 90 and a second side 91 and such that the core width is greater than the core thickness, a folded shape such that the first side 90 and the second side 91 form a slot 10 whereby the slot 10 provides an entrance to a cavity 92 where the cavity 92 is continuously open from one longitudinal end to the other longitudinal end and along the slot 10 form end to end, whereby the cavity 92 is further comprised of: a relatively constant open cross-section perpendicular to the longitudinal dimension, and an inner surface 96 comprised of part of the continuously electrically conductive wire 93 on the surface running in a direction mostly perpendicular to the longitudinal dimension whereby, the conductive wire forms a circuit and application of voltage to the circuit creates a magnetic force longitudinally along the cavity and longitudinally along the core such that the magnetic poles of the cavity magnetic field are opposite the poles of the core 95.

About Open-sided Coil—Preferably, the slot 10 has a uniform width from end to end along the cavity 92 where the width is less than the widest part of the cavity. A cumulative coil may be comprised of rings of wire that form round coils on part of the cumulative coil and open-sided coils on another part of the cumulative coil. An open-sided coil may be comprised of a wire with repeating paths of the following sequence: path of inner partial winding, path by slot with transition from inner partial winding to outer partial winding, path of outer partial winding, and path by slot with transition from outer partial winding to inner partial winding. A partial winding is a winding that is less than a complete loop. The coil may have AC or DC current applied to be magnetically active or may react to a magnetic field. The surroundings to a coil is all that is outside the surface of the open-sided coil formed by the surface enclosing the outer partial coil, the slot, and the two ends.

A horseshoe electromagnet may be used in this embodiment. A horseshoe electromagnet is an electromagnet with poles next to each other like a horseshoe magnet. Preferably, open-sided magnet coils and the horseshoe magnetic coils are symmetric to the vertical plane going through the propulsion line 2 when the coils are engaged with the propulsion line. In this symmetric position, the coils are in defined to be in their horizontal position which is their normal position for engaging with the propulsion line 2.

Hybrid Propulsion Line—A hybrid propulsion line has both sections of ferromagnetic (or magnetic) and conductive (non-ferromagnetic) material. The ferromagnetic sections are used to provide attractive propulsion force while the conductive sections are used to provide strong repulsive forces between the inner partial coil on the carriage 5 and the propulsion line 2. The propulsion carriage (for use with hybrid propulsion line) contains multiple open-slot electromagnets to provide the ability to pull toward ferromagnetic (or magnetic) sections of the propulsion line or to repel way from conductive sections of the propulsion line. The strongest attraction-based propulsion uses ferromagnetic or magnetic (hereafter F/M) sections of length about equal to the length of the electromagnet with spacing between F/M sections about equal to the length of the magnet. The open-sided coil 89 magnet turns on when the center of the open-sided coil is about half way between F/M sections and turns off when in the middle of a F/M section. Conductive sections of the propulsion line may be arranged to allow alternating current to be applied to carriage's 5 open-sided coil 89 to provide levitation without propulsion. Also, the addition of a conductive section between the F/M sections adds to the force forward.

The long-stator system provides for opportunities to transfer energy to the vehicle. When the conductive sections of the propulsion carriage are in a coil configuration (normal coil or open-sided coil), a voltage is produced in the coil, and that voltage is able utilized by the vehicle or stored in batteries on the vehicle.

For each of the long stator and short stator examples, the description is provided in terms of the coil (normal or open-sided) being on either the carriage or part of the propulsion line. In general, propulsion and/or levitation is possible independent of whether the coil of each of these is on the carriage 5 or part of the propulsion line 2. The propulsion line could be an open-sided tube rather than a cable; however, the cable has an advantage of increased tensile strength.

Asymmetric coils—A standard electromagnet of uniform diameter is symmetric around the point of the geometric center. It is also symmetric around a longitudinal center line of the electromagnet.

An open-sided electromagnet, unless otherwise specified, is symmetric about the plain that extends through the longitudinal center line of the magnet and the center line of the slot of the magnet. It is also symmetric around the longitudinally-perpendicular plain that is both perpendicular to the longitudinal center line of the magnet and goes through the geometric center of the electromagnet.

For purposes of this document, an electromagnet that is not symmetric around the longitudinally-perpendicular plain is identified as longitudinally asymmetric.

A cone-shaped coil defined as a magnetic coil in the shape of a cone, rather than a cylinder, is longitudinally asymmetric. The (magnetic) flux density at the small-diameter end of a cone-shaped coil in greater than at the large-diameter end. An open-sided cone-shaped coil having a uniform cross section of the cavity that forms a straight slot along the side of the cone has a greater flux density in the cavity at the small end of the cone than at the large end.

A standard electromagnet without a core that is bent around a plastic cylinder such that one end forms an open-sided coils (around the plastic cylinder) and the other end of the electromagnet remains unbent becomes longitudinally asymmetric. If a mold is placed around the plastic cylinder and electromagnet and the plastic cylinder is removed, a uniform cavity replaces the plastic cylinder. The flux is greater at the open-sided coil end of this cavity. A straight slot along the side of the cavity along the edge farthest from the coils creates a longitudinally asymmetric coil capable of interacting with a propulsion line to create propulsion. This illustrative example both describes a method to manufacture this longitudinally asymmetric electromagnet, and also, defines an example electromagnet device. The device and method is not limited to cavities shaped from cylinders.

An additional embodiment is comprised of a magnetic coil wound to form a horseshoe magnet that is bent around a plastic cylinder to form a longitudinally asymmetric coil such where: a) both ends of the horseshoe magnet form geometrically similar open-sided coils with cavities at one end of the plastic cylinder and b) the other end of the plastic cylinder rests on but does not bend the middle-most coils at the longitudinal-middle of the horseshoe magnet. A resulting open-sided mold formed around the plastic cylinder results in cavity that has a higher flux at one end than the other.

In the general sense, a mold that preserves the shape of a magnetic coil, core, cavity, and slot may be a thermoset polymer that holds the components in place or may be any of a range of mechanical constraints that serves the same purpose. In the general sense, the cavity forms a shell 103 through which an insert 104 passes and the slot forms a path through with connections to the insert pass. More specifically for the embodiments of this invention, the shell 103 and insert 104 engage to form a linear motor. An example of a shell 103 is an open-sided reactive tube 98, and an example of an insert 104 is a propulsion line 2. The shell 103 component of the linear motor may be either on the carriage 5 or the propulsion line 2; and likewise, the insert 104 component may be either on the carriage 5 or the propulsion line 2.

FIG. 15 illustrates a bent horseshoe electromagnet 105 may engage with a propulsion cable 106. The cable is comprised of strands of wire 107. Shielding 108 reduces electromagnetic interactions between to the bent horseshoe electromagnet 105 and the cable 106 until the cable is to the left of the horseshoe electromagnet 105. Induction forces propel the horseshoe electromagnet 105 relative to the cable 106. The ends of the bent horseshoe electromagnet are preferably open-ended coils that encase the cable 106.

A short-stator embodiment may use a longitudinally asymmetric shell 103 where the magnetic flux density in the cross section defined by the perimeter of the inner wall (that is uniform to match the component it engages with) is denser at one end of the cavity 92 than at the other end. When an electric current of changing magnitude is put through the coil, a net force vector is experienced by the reactive component insert 104 (component engaged by the coil) away from the electromagnet in the direction of the cavity 92 end with the high flux density that intersects the reactive component insert 104.

The shell's 103 coil may be an open-sided cone shape with a wide end and a narrow end opposite the wide end. Shielding is preferably selectively on the wide end (inside the coil) and is of the type the reduces the magnetic field density in center section of the wide end. The general design and operation of the longitudinally asymmetric open-sided coil is to generate a magnetic field of greater flux density at the narrow end such that when the longitudinally asymmetric open-sided coil surrounds a uniform conductive cable, changes in current of the coil will lead to a propulsion force on the coil from the narrow end to the wide end.

The horseshoe magnet 105 embodiment is not limited to a specific shape. The embodiment includes ends (poles) of the magnet where, preferably, alternating magnetic flux is expressed in a first longitudinal direction from the magnet 105. A combination of coils and or core direct the flux from pole-to-pole with a minimal of flux exiting/entering the magnet 105 in a direction opposite the first direction. A plane of reference for the longitudinal directions is the plane perpendicular to the longitudinal direction (axis) and at the ends/poles of the magnet 105.

Preferably, the cable has vertical planes (perpendicular to the longitudinal axis) of conductivity separated by vertical planes of insulation to conductivity so as to allow a repulsive propulsion force from a single phase alternating current.

Long Stator Alternative Embodiment—A reactive insert 104 may be comprised of materials that provide attractive interaction, repulsive interaction, or longitudinally spaced combinations of attractive and repulsive interactions. A reactive component may be a coil that generates current and voltage in a wire conductor. A reactive component may be a coil of a shell 103 with the active component an electromagnet in the insert 104. A reactive component may be a simple metal tube with a slot 10.

Switching—A method of switching is where the propulsion line cable is part of a propulsion line 2 for a short stator embodiment is represented by the same image as the propulsion line electromagnet for the long stator embodiment. Likewise, an open-sided propulsion carriage tube is illustrated for the long stator embodiment by the same depiction as the open-sided propulsion carriage electromagnet for the short stator embodiment.

In the long stator embodiment, two open-sided propulsion carriage tubes (reactive components) are connected and positioned between two series of propulsion line electromagnets (active components, e.g. electromagnets). At switching regions two series of propulsion line electromagnets” allow for interaction with either of the two open-sided propulsion carriage tubes. The two series of propulsion line electromagnets proceed to different paths in the switch maneuver where the path taken by the propulsion carriage is the switch line.

The preferred method for the switch proceeds to following the switch line in the following sequence: a) only the electromagnets on the switch line are activated (or are activated to a much greater extent than the other line) and b) the open-sided propulsion carriage tube is tightened around the switch line and widened around the opposite line to allow the carriage to be disengaged and separate from the opposite line.

In a short stator embodiment, the open-sided propulsion carriage electromagnet has a slot capable of mechanically widening or narrowing to engage (or disengage) a propulsion line cable to perform a switch. The short-stator switching sequence includes: a) only the open-sided propulsion carriage electromagnet s around the switch active are activated (or are activated to a much greater extent than the other line) and b) the open-sided propulsion carriage electromagnet is tightened around the switch line and widened around the opposite line to allow the carriage to be disengaged and separate from the opposite (non-switch) line.

Switching Without Moving Parts—When the reactive counterpart is of an open-sided design (e.g. cross section is shape of horseshoe to a first approximation), the sides of the slot are optionally made in a manner whereby the geometry creates a greater induction force at the slot that opposes the exit (disengaging) of the propulsion line from the coil. When this design is used in the switching configuration, stitching is controlled by the activation of electromagnets. The switch is performed without moving parts. In general, asymmetric designs allow for the stable levitation even though the components are not physically blocked from going apart. A similar design of the active component would allow a stable (levitation) position of a cable inside an open-sided electromagnet.

Simple Configurations—A preferred design for a propulsion line consists of a joist with either a cable attached below the joist or electromagnets attached below the joist. The electromagnets need not be continuous with preferred designs having multiple electromagnets in the carriage at one time.

In the most-preferred design for the long-stator design electromagnets are both on the propulsion line and the propulsion carriage. Here, the propulsion carriage interacts with the propulsion line to provide both levitation and propulsion. This is performed using an open-sided electromagnet where the inner surface configures to allow passage of the electromagnet and is designed to interact with the bottom of the joist.

In a short-stator configuration, the circular component line may be a cable. In the long-stator configuration, the circular component may be an electromagnetic coil that is most-preferably located at the connecting cables to the joist. The joist reinforces longitudinal straightness while a cable provides extra tensile strength to hold the weight of a vehicle if the vehicle does not have adequate lift. An auxiliary cable may be placed on the long-stator embodiment.

Hybrid Stator Configuration—The asymmetric open-sided coil embodiment for long-stator and short-stator configurations allow for a single propulsion line cable or single series of propulsion line electromagnets to provide both propulsion and suspension. The long stator embodiment is also able to provide power transfer to the vehicle.

An embodiment may be a long stator attached to the upper part of the propulsion line joist and a cable (reactive to a short stator) on the lower part of the propulsion line joist. A Hybrid Propulsion Carriage has both an open-sided propulsion carriage tube for interacting with the long stator and open-sided propulsion carriage electromagnets for interacting with the propulsion cable. A configuration with one open end up and the other down can match a propulsion line configuration and is physically blocked from derailing and allows for switching similar to the previously described method.

Cables, empty shells, or tubes could be put in place of the electromagnets in the long stator configuration when the propulsion line is designed for transit with the short stator embodiment. The propulsion carriage could periodically change from long stator to short stator propulsion whereby batteries on the vehicle are charged when using the long stator embodiment.

Wind Turbine Option

Wind Turbine Option—For large wind turbine systems, the tower/post that supports the wind turbine is only about 10% of the total investment and often of the same scale as the cost for electrical infrastructure. This embodiment consists of the following:

a) extending the tower to about twice its normal height. b) attaching a wind turbine 105 with the axis of rotation 106 off to one side of the center of the tower in a manner that it can turn with changing wind direction going outside a circumference of structural support of the tower extension above the region of this shaft. c) connection of a suspension cable at the top of the tower. d) connection of the wind turbine such that it rotates above a lower propulsion line, inside connecting cables that connect the upper suspension cable to the lower propulsion line, and below the suspension cable.

The upper suspension cable optionally provides a vast part of the electrical infrastructure for a series of wind turbines in this configuration, and optionally provides power distribution for use by vehicles traveling on the propulsion line.

For rural areas with wind power potential, Terreplane suspension cables could be supported by this type of infrastructure with typical distances between posts being 0.1 to 2.5 miles and most preferably between 0.975 and 0.5125 miles. As a benchmark, high voltage power lines are often space at five per mile.

This wind turbine combination device is a suspension cable tower/post that supports a wind turbine comprised of a tower that is 1.05 to 3 times the diameter of the wind turbine path, a means of attaching a rotor bearing for the shaft of the turbine such that shaft is off to one side of the center of the tower in a manner that the shaft can orient toward the direction of wind whereby the shaft never crosses the turn support structure of the tower as extended above the region of the shaft whereby an effective second tower bearing (rotation embodiment) is on the tower at the region of the shaft along the tower with the inner part of the tower bearing attached to the tower and the outer part of the tower bearing attached the outer part of the rotor bearing said system further comprised of: a)—connection of a suspension cable at the top of the tower, and b) region of the wind turbine shaft along the vertical dimension of the tower such that the rotor rotates above a lower propulsion line, inside connecting cables that connect the upper suspension cable to the lower propulsion line, and below the suspension cable.

Linear Motor Options—The open sided coil, and especially the bent horseshoe electromagnet 105, may be used in linear motors as well as other applications where it is desirable to impart velocity on an electrically conductive element relative to the coil 105. For example, projectiles may be expelled from coil-containing devices such as a gun or nail driver. A series of weakly-connected projectiles may be propelled as a continuous feed that decouples during acceleration by the coils. In the case of projectiles being projected by a horseshoe electromagnet, a tube may be used without a slot. The configuration of the tube is not limited to a cylindrical configuration.

Within the context of this invention, linear motor is referred to a devices that moves an insert, such as in the insert 104 of FIG. 14, relative to the coil where the insert may have active, induced, or other magnetic fields.

In its basic embodiment, the projectile ejecting embodiment is a linear motor from which a projectile is ejected comprising: a horseshoe electromagnet, a tube located between the ends of the electromagnet, and ends of the horseshoe electromagnet located symmetric to a plane going through the propulsion line. The horseshoe electromagnet accelerates an insert that is propelled from a region where the horseshoe electromagnet resides.

Molding

For the molded electromagnet devices of this invention, the following are placed in the mold along with a solid-forming liquid (or paste): electromagnet coils and ferromagnetic solids or particles. Hereafter in this invention description: 1) the term “liquid” refers to a material having a consistency between that of a paste to that of a free-flowing liquid and 2) the term “ferro-objects” refers to ferromagnetic materials of size or shape from that of a small particle to that of a larger solid object like a rod.

A solid is formed from the liquid that is placed in a mold. The ferro-objects form the core of the electromagnet device.

Examples of solids that are formed are: thermoset polymers, other polymers, ceramics, and porcelain. The many materials known to form solids from liquids may be used in this invention. Example materials to form thermoset polymers are isocyanates, polyols, epoxy resins, and phenolic resins.

Novel Self Assembly

During molding, a self-assembly process assembles an improved electromagnet core relative to a core of random ferro-objects. An electric current is applied to the coil in the mold. The current energizes coil and forms a magnetic field. The ferro-objects move to improved positions, forming an improved core, in response to the magnetic field.

As part of the process, the solid-forming liquid: 1) surrounds at least part of the coils and ferro-objects and 2) forms a solid. These two steps form a solid structure with the ferro-objects set in the improved positions.

Optionally, the solid-forming liquid forms the outer surface of the device.

Mold Options for Enhanced Self Assembly

External magnetic coils may be used in combination with coils in the mold to form stronger magnetic fields of the desired shape. Typically, these external coils are placed pole-to-pole with the internal coils; this is referred to as being coupled with the internal coils. When energized, an external coil is a magnet. Energize indicates a voltage is applied. The term “voltage applied” indicates the coil is in a circuit and current flows through the coils.

Optionally, ferromagnetic or electrically-conductive materials outside the mold may be used to influence the magnetic field in the mold. A skin (or shell) may be placed along the inner surface of the mold; this skin would become an outer surface of the cast.

Inserts may be placed in the core to: a) enhance heat transfer, b) improve strength, c) assist formation of improved Eddy currents, d) provide monitoring capabilities, and e) provide control capabilities.

The following are examples of inserts to enhance heat transfer: a) a fin that extends into and out of the cast (i.e. device being molded), b) a duct passing through the cast with an entry and an exit at the surface of the cast, c) a removable insert that has an entry and an exit at the surface of the cast, and d) a thermally-conductive skin. An example of a removable insert is an insert that melts or dissolves (e.g. water soluble filament) at conditions not harmful to the cast.

Non-inclusive examples of ferro-objects includes ferromagnetic particles and short sections of ferromagnetic rods.

The ferro-objects may be (but are not limited to) powders of iron, carbonyl iron, hydrogen-reduced iron, MPP (molypermalloy), Supermendur, High-flux (Ni—Fe), Sendust, KoolMU, or nanocrystalline. Powders are comprised of particles. The largest dimension of the particles are preferably between 10 nm and 0.2 mm; and more-preferably between 50 nm and 50,000 nm.

These ferro-objects form a composite with the solid-form liquid. Methods known in the art and science can be used to advantage to improve the strength of the composites and to create a higher packing of ferro-objects in the core that is formed. By example, a large solid object of out perimeter similar to that of the inner core surface may be placed inside a coil in the mold with powders filling the gaps between between the object's outer perimeter and in the inner core surface.

Multiple rod sections may be used as ferro-objects. The rods, or other objects, may be placed end-to-end to form a long inner core.

When powders are placed in a mold prior to placing the solid-forming liquid into the mold, it is preferred to place the contents of the mold under vacuum prior to introducing the solid-forming mixture. The vacuum reduces amount of powder that is not wetted with the solid-forming liquid in the cast that is formed.

For powders in a solid-forming liquid, a flowing mixture at 20%-60% by volume (more preferably 30%-50%) can be influenced under magnetic fields to form higher densities up to 60%-90% (more preferably 65%-85%) by volume. Preferably, the magnetic fields form the higher densities in the inner core.

More-expensive higher-saturation flux powders may be placed in magnetic field bottleneck areas with less expensive materials used in other core volumes. Here, saturation flux is magnetic saturation flux.

Powders may be introduced to the mold after higher-densities are formed. This allows for the final cast's powder content to be higher than what readily flows in a mixture of power and solid-forming liquid.

It is preferred to mold/glue wires of the coil into a shape prior to placing in a the mold. This allows for more-complex coil designs and can reduce the difficulty of the molding process.

A Preferred Molding Method

A preferred molding method is a method for fabricating an electromagnetic device comprising: placing at least one insulated wire coil in a mold, placing a solid-forming liquid in the mold, placing a plurality of solid particles in the mold said solid particles having saturation fluxes greater than 0.5 Tesla, applying voltage to said wire coil; wherein the coil forms a magnetic field said magnetic field changes the solid particle positions forming volumes of increased solid particle concentrations (overall densities) and wherein the solid-forming liquid forms a solid.

The method preferably forms an electromagnetic device with an inner core and an outer core.

Optional enhancements of this preferred method include: placing a solid magnetic core within the wire coil, placing a ferromagnetic object having at least one dimension greater than 1.0 mm in the position of an inner core of the wire coil, placing a duct-forming insert in the mold, placing a rotating device in the mold said rotating device is coated with a removable coating, and placing a magnet outside the mold that is pole-to-pole with the inner core to be formed in the mold.

An example of a solid magnetic core is a ferromagnetic object having at least one dimension greater than 1.0 mm.

More-specific embodiments of the method are wherein: the solid-forming liquid is a mixture of monomers and the solid is a polymer, the solid-forming liquid is a mud and the solid is a ceramic, said insulated wire coils is comprised of wire with an outer thermoplastic coating, the device is a joint flexible in directions lateral to longitudinal dimension of the pole and increased current in a coil surrounding the pole increases stiffness of the joint, the solid particles are mixed with the polymer-forming liquid prior to placing in the mold, additional solid particles are placed in the mold after volumes of increased solid particle density are formed, the polymer-forming liquid forms a thermoset polymer, materials of high magnetic interaction are placed outside the cast volume of the mold, the high magnetic interaction materials are ferromagnetic, the high magnetic interaction materials are ferromagnetic, and the high magnetic interaction materials are electrically conductive and the magnetic field is of varying polarity.

Optionally, during the formation of the core, the liquid may be circulated. The entire mold may be oscillated or turned so as to move the magnetic particles such that the particles may position then stay in optimal positions. Sonic waves can also assist movement of particles.

It is preferred to mold the coils into shape before inserting into the mold/cast; this shaping can be assisted by having a thermoplastic coating around a more-fixed insulator where pressure and/or heating is sufficient for adjacent wires to set when in contact.

A Preferred Molded Device

A preferred molded device is a molded electromagnetic device comprised of: an exterior wall, a continuous polymer phase said polymer phase comprising a thermoset polymer surrounding a plurality of particles having saturation fluxes greater than 0.5 Tesla; wherein the thermoset polymer and particles form a solid composite electromagnet core said core have a plurality of regions of different average densities and wherein a first region of highest average density is an inner core (inside the coil), a second region of lower average density is in the outer core and adjacent to the coil (outside the coil at a region of lower radius than median outer core radius), and a third region of lowest average density is outside the coil and further distant from the coil than the second region of lower average density (is the outer core at region of greater radius than median radius).

More specifically, the first region has a saturation flux greater than 0.5; and more preferably between 0.8 and 2.5. The outer core region adjacent to the coils (second region) has a average saturation flux between about 0.2 and 2.5 and more preferably between 0.3 and 1.2, and this average is at least in part comprised of a mixture of ferro-objects having saturation fluxes between 0.5 and 2.5 with maximum dimensions less than 1 mm surrounded by a continuous solid phase having saturation fluxes less than 0.4. The third region has a average saturation flux between about 0.2 and 1.5 and more preferably between 0.2 and 0.8, and this average is at least in part comprised of a mixture of ferro-objects having saturation fluxes between 0.5 and 2.5 with maximum dimensions less than 1 mm surrounded by a continuous solid phase having saturation fluxes less than 0.4.

Here, the radius is from a longitudinal center axis of the inner core. In the case of a long toroidal electromagnet, the longitudinal axis is the center line of the inner pole of the electromagnet.

Unless otherwise specified, the longitudinal axis/dimension is a line of symmetry that best approximates the line around which the coils of the electromagnet are wound.

Optional enhancements of the device of the preferred device include: the third region of lowest particle density forms the outer wall of the electromagnetic device; and said electromagnetic device further comprised of a first set of coils, a second set of coils, and a cooling fluid duct between the first set and second set of coils.

A Rotary Motor Molded Device

The molded device may be a rotary electric motor which is an electromagnetic device comprised of an armature said armature having an axis of rotation, said armature having a sequence of magnetically interactive shells radially spaced from the axis of rotation, a stator said stator having a sequence of wire coils. In this configuration, electromagnets located between adjacent cylindrically-shaped conductive shells would add to forces on at least two shells.

Here, the “shells” are hollow cylinders; preferably electrically conductive shells that are reactive surfaces of an induction motor. Preferably, these shells are laminated with planes of insulation extending radially.

This embodiment is on electric induction motors that use the following technologies: a) injection molded stators with self-assembling electromagnet cores for complex yet low-cost electromagnet fabrication, b) stacked cylinder electromagnets that utilize both poles of electromagnets on separate aluminum cylinders and c) direct contact air cooling of both sides of the electromagnets. FIG. 16 compares a conventional induction motor to the stacked rotary induction motor.

A conventional rotary induction motor as one reaction surface armature 111 that is a cylinder (shell), stator electromagnets 112, and a stator core. The stacked rotary motor has an outer 114 and inner 115 reaction surface armatures and electromagnets 116 with cores 117 between the co-centric cylinders. An expanded view if the cores 117 (FIG. 17) of the stacked rotary induction motor reveals a partial horseshoe shape and an air gap 118 between the coils for cooling.

The stacked rotary induction motor places the electromagnets/cores/stator between rotors that rotate on a common shaft emerging from one end of the motor. In this design: both ends of the coils are in contact the air gap next to rotors making enhanced heat removal possible when a cooling fluid is circulated in this space, many coils engage two rotor armatures, it is preferred to have cores of a partial horseshoe configuration, and the stator is secured to be stationary while the rotors rotate.

A Linear Motor Molded Device

A molded device may be a linear motor, the linear motor comprising: a short stator said stator having longitudinal sections of a front fifth, middle fifth, and rear fifth; a longitudinally extending armature said armature having a lateral width, a vertical height, a first side and a second side said second side opposite the first side, a first series of stator electromagnets said first series exerting a lateral force on the first side of the armature, a second series of stator electromagnets said second series exerting a lateral force on the second side of the armature (or second armature parallel to the first armature), a front average separation distance said front average separation distance being an average of distances separating the first series (of magnets) from the second series located in the front fifth of the short stator, a middle average separation distance said middle average separation distance being an average of distances separating the first series from the second series located in the middle fifth of the short stator, wherein the front average separation distance is at least twenty percent greater than the middle average separation distance.

The preferred armature is a monorail of a transit system.

Optional enhancements of the linear motor include: a means of measuring the clearance gap between a point on the front fifth of the stator, a means of changing the force on the short stator in the direction of the closest point on the armature rail to the short stator, and a control means which inputs the clearance gap measurement and controls the force based on a control algorithm.

Time-averaged clearance gaps for the middle fifth the linear motor are preferably between 1 and 8 mm and more preferably between 2 and 5 mm.

FIG. 18 illustrates a U-shaped cross section of the preferred short stator where the stator has electromagnets on opposite sides of a monorail have reactive rail features, left coils 119 and right coils 120. The entire monorail 121 may be conductive or conductive strips 122 may be attached along the sides. If a conductive strip distributes grid electricity, it must be insulated from a path to the ground; and if one strip is a ground strip and the other a power strip, the two strips must be insulated from each other.

Repulsive forces on the pair of electromagnets translate to forces with lateral components (in addition to longitudinal) on the short stator y including a region on the top 123 of greatest stress that acts like a hinge to slight bending actions.

The region of a joint 124 is advantageous on the top 123 to be able to vary the stiffness of the joint; basically increased current in the coil of the joint increases stiffness and reduces the lateral separation of the pair of coils at a given lateral force between the pair of coils. This allows slight changes in clearance to be controlled independent of propulsion force.

A Solid State Control Joint Molded Device

FIG. 19 is an example of a solid state control joint. The control joint comprised of a helical electromagnet 125 around a longitudinal inner core of solid core components 126 separated by flexible solid material 127. The solid core components are preferably ferro-objects that fit together in a manner that provides flexibility perpendicular to a longitudinal centerline of the longitudinal inner core. An outer core 128 reduce increase the strength of the magnetic field.

A joint having controlled flexibility preferably comprises: a flexible electromagnet core said core having discrete ferromagnetic sections separated by flexible sections along a longitudinal dimension of the core, a coil surrounding the flexible electromagnetic core; whereby increased current in the coil induces increased longitudinal attractive forces of the discrete ferromagnetic sections resulting in greater resistance to core flexibility in at least one direction perpendicular to the longitudinal axis of the core.

Optional enhancements of the joint of joint include: having flexible sections are a thermoset polymer, having a a pseudo line of pivoting movement resulting in the separation of magnets along opposite sides of an armature of a linear motor, having end-to-end adjacent ferromagnetic sections have matching male and female geometries where the male geometry is of a shape between that of a ball and a cone, having discrete core sections have maximum dimensions greater than 0.01 mm and less than 300 mm, and having injection-molded flexible polymer separating solid ferromagnetic sections as a solid-state joint.

This joint may have the shape of a rod and can serve as a rod of variable stiffness for applications line supporting a wheel and serving as a shock absorber. The joint may be of the general configuration of a horseshoe electromagnet.

A Thin-Walled Tube as Coil Wire Molded Device

Molded construction is particularly useful for thin-walled materials to create additional strength. For copper, or other metal, tubes that serve as conductors for an electromagnet, the wall thickness tends to be much greater than needed for the current loading. A molded construction provides needed structural strength.

A preferred thin-walled tube coil electromagnet is an electromagnet coil comprised of: a tube bent into a coil configuration said tube comprising a first end, a second end, and a fluid volume; insulation on the outer surface of the coil, a fluid entry port located on the first end and a fluid exit port on the second end, a plurality of electromagnetic core regions of different average densities, an electric circuit connection surface near the first end and a circuit-completing connection on the second end (basically, a means to connect the tube to a circuit to provide flow of electrons through the coil) wherein the tubes are surrounded by a continuous solid phase.

Optional enhancements of the thin-walled tube coil electromagnet wherein: no insulation is on the tube with application in a high temperature application like an induction welder (the continuous solid phase may be a ceramic or porcelain), the tube is of a radial perimeter other than circular, the tube is generally of a rectangular radial perimeter, the average tube wall thickness is less than one third the average radial dimension of the tube volume, the average tube wall thickness is less than one tenth the average radial dimension of the tube volume, the average tube wall thickness is less than one twentieth the average radial dimension of the tube volume, the tube coils are substantially contained in a continuous polymer phase where said polymer phase increases structural strength relative to the tube coil without polymer phase wherein the polymer phase adheres to the outer surface of the tube coil (basically, the objective is to reduce the amount of copper in the wall to the extent possible so as to reduce weight and thin walls have insufficient structural strength for the application but boding of the walls into a larger essentially honeycomb-like structure provide structural strength), a honeycomb-like polymer structure of a continuous closed path of insulating material form an electromagnetic path wherein a conductive material is flowed through the structure coating the structure toward forming an electrically conductive layer, the composite of tube and polymer is 3D printed, the tube surfaces on at least part of the coil perimeter are bonded to the core, and the tube are connected to a fluid circulation means.

A Coil with Cooling Cavity Between Wires Molded Device

A preferred efficiently cooled electromagnet coil is comprised of: insulated coil wires; a cooling cavity located between coil wires said cavity comprising a volume of fluid, an entry port, and an exit port; whereby a fluid flows through the entry port, the volume, and the exit port; and wherein said fluid removes heat from the coil wires.

Optional enhancements of the coil with the cooling cavity are wherein: the coil wires are around an electromagnetic inner core, said cavity is generally annular in shape and the exit port is at the most distant region on the volume from the entry port, at least some of the coil wire is in direct contact with the fluid (no insulation between wire and fluid but with electrical insulation between wires), the cavity is generally parallel to a longitudinal axis of the pole, adjacent wires are bonded by adhesive (the wires are glued together to reduce deformation and to retain a fixed bulk geometry), coil wires separate the cavity volume from the inner core, a conductive metal surface separates the cavity volume from the inner core, the conductive metal surface is comprised of a copper foil, and the wires and core are connected by a thermoset polymer, the orientation is of natural convection the fluid undergoes at least partial evaporation in the coil.

Optional enhancement is a heat pipe built into the molded device. This embodiment preferably has: a cooling heat transfer surface (skin) as an outer body surface wherein ducts for flow of the fluid contact the outer heat transfer surface, and the cooling fluid undergoes evaporation between the coil wires and condensation next to the outer surface and wherein at least one duct along the outer heat transfer surfaces connects the entry port to the exit port.

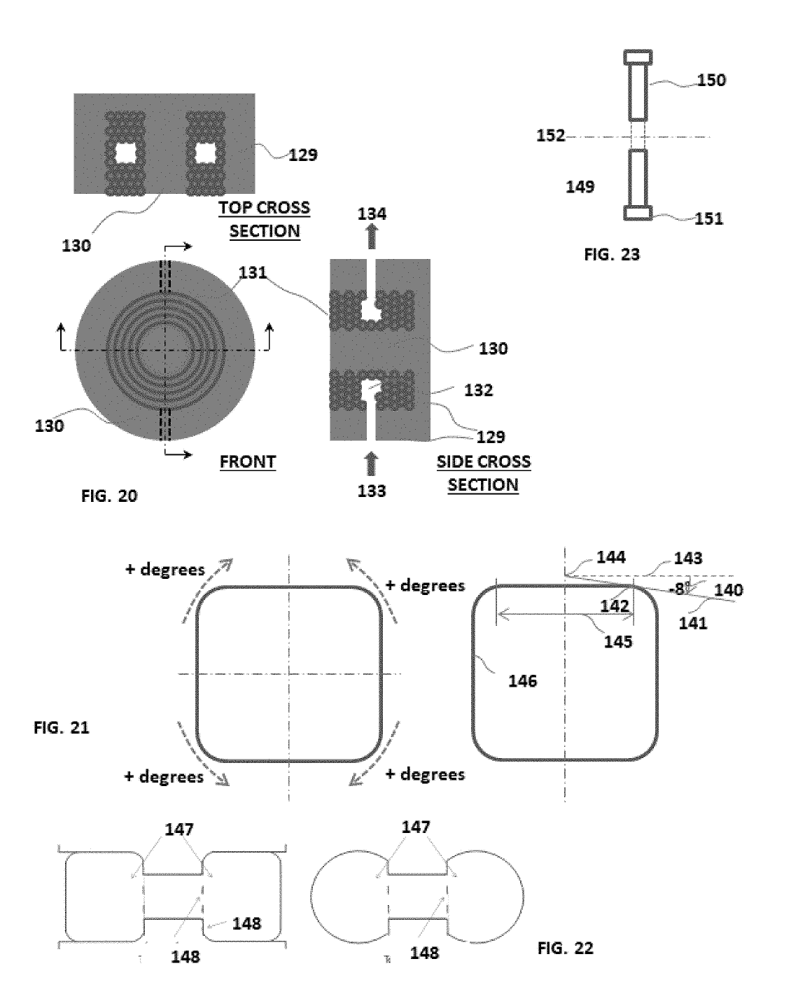

FIG. 20 illustrates the front, horizontal cross section, and side cross section of a toroidal coil with a toroidal cooling cavity in the coil. The figure illustrates an outer core 129, inner core 130, the coil 131, cavity 132 between wires of the coil, a heat transfer fluid entrance 133, and a heat transfer fluid exit 134. Ports on opposite ends of a diameter of the toroid provide regions for a cooling fluid to enter and exit.

The cavity may be end-to-end in the coil. The cavity may be made by rolling a meltable/dissolvable cord next to the wire of a magnetic coil for part of the rolling processing.

Molding of the outer core with or without an outer metal sheet (or foil) layer allows the outer core surface to be ribbed corrugated surface, or otherwise of design for improved heat transfer.

Enhanced Linear Motor Device

Grid power may be distributed in the armature rail of a linear induction motor where the short stator contacts the reactive rail at a point to receive electrical power.

Alternative to an overhead rail where grid power is distributed by the armature rail, the armature rail may be put at ground level with electric power applied to the rail only when a train is the in the proximity. A sensor would sense the train and provide power to the third rail when the rail is near and/or under the train.

The overhead monorail is preferably unrolled from a reel including constructions such as cables (e.g. wire rope), bands (e.g. steel bands), and combinations thereof.

In the production of more-complex motors made possible with molding, an optional embodiment is where the center part of a rotary motor is an open cylinder for air flow and where propellers rotate both in and out of the motor shell surrounding the hollow cylinder center (hollow except for optional propellers). This configuration allows for ram-jet or jet performance options if fuel is burned in the middle part of the engine.

Enhanced Battery-Powered Aircraft and Tethered Gliders

Short-hop battery-powered aircraft potentially have use in major market segments because of high reliability of electric motors and low infrastructure requirements to maintain aircraft without liquid fuel. Enter into this arena electric motors that are 15% to 25% the weight of the current best available technology, and these aircraft can begin to dominate. It is possible to have shorthop aircraft provide costs and access like Megabus, but with transit times faster than any alternative.

Monorail Linear Motor Designed to Handle Sag

A linear motor short stator configured to engage a monorail armature preferably is able to operate with both lift forces on the upper surfaces of the monorail and regular variations of a centimeter or more in the vertical clearance. This operation allows for less expensive rail configurations. This embodiment is comprised of a short stator with lateral clearances between propulsion magnets and the reactive rail of 1 to 10 mm on both sides while vertical clearances may vary from 1 to over 30 mm during transit. Preferably the lower part of the short stator cavity (or other blocking device) is sufficiently distant from the upper surface of the short stator cavity to allow for this variation is vertical region of the monorail in the cavity.

A short stator can be effectively configured around a monorail.

Aspects of a switching method including a main guideway 135, a switching guideway 136, a narrowed main guideway 137 at the switch region, a main chassis 138, and a switch chassis 139. Aspects include options of: A) travel not at a switch region where no switch guideway is present and no derail guard is needed, B) aligned main and switch chassis travel right under the switch guideway if a switch is not desired and where the switch rail blocks the main/lower chassis from derailment, C) an approach to a switch region where the switch guideway is switched up in preparation for the switch and a degrail guard bocks the side-rail of the main chassis to prevent derailment where the switch rail can appear gradually from the side as a point (e.g. of an arrow) and gradually broadens along the longitudinal path to substantiate a full guideway width and height, and D the chassis in the switch position at a switching guideway region where vertical separation of the switch rail results in the main/lower chassis slipping up and away from the main guideway.

The most-preferred embodiment of this invention is an aircraft with an upper lift path surface (hereafter upper LiftPath) and a lower lift path surface (hereafter lower LiftPath) on the upper and lower surfaces of the fuselage, respectively. The LiftPaths are generally rectangular in shape having a width similar to the fuselage width and a length along most of the fuselage. During flight the LiftPaths bend air downward to create a lift force and transfer that force to the aircraft on surfaces of relatively low pitch so as to preserve a high ratio of lift to drag forces. Preferred applications include but are not limited to fixed wing aircraft and tethered lifting-body gliders.

Surface slant 140 (also referred to as slant angle) is illustrated by FIG. 21 and is critical in the specifying of the embodiments of this invention. In this Specification and Claims, slant 140 is an angle formed in the vertical-lateral plane between a line tangent 141 to a surface 142 and a horizontal plane 143 with the vertex 144 at the aircrafts plane of symmetry. Surface slant 140 is defined for a surface with the aircraft at zero roll and zero angle of attack. In a forward facing position, positive slant angle changes are counterclockwise for upper surfaces on starboard side and lower surfaces on port side and clockwise for upper surfaces port side and lower surfaces starboard side.

The Liftpath width 145 is defined in terms of a generally flat, concave, or piecewise flat surface said width 145 having a horizontal lateral dimension of length between points on LiftPath edges said edges generally specified wither the surface slant progresses from more than −8 degrees to less than −8 degrees.

### More Preferred Embodiment

In the more-preferred embodiment, the aircraft has: a center of gravity, an exterior surface, an aircraft front, an aircraft tail, a maximum width, surface pitch angles relative to a reference plane, and surface slant angles 1.

The more-preferred aircraft comprises (a) a fuselage; (b) a plurality of high-lift-to-drag-capturing surfaces having: surface areas, pitch angles between 0 and 2 degrees, an average pitch angle, and slant angles between −4 and 4 degrees; (c) a plurality of lift-stabilizing surfaces located behind the center of gravity having: surface areas, pitch angles between −2 and 1 degrees, slant angles between −4 and 4 degrees, and an average pitch angle less than the average pitch angle of the lift-to-drag capturing surfaces; (d) at least one lift path surface (LiftPath) extending longitudinally on the fuselage having: a median width, a median length, a surface area, a fore end, an aft end, a port edge, and a starboard edge; and (e) a payload compartment in the fuselage having a median maximum width and a median length.

Further more-preferred aspects are the aircraft wherein: (i) the lift path surface is within the aircraft's exterior surface with a transition from the edges and ends of the lift path surface wherein the transition at the port and starboard edges has slants greater than −2 degrees, the transition at the aft end has pitches greater than −2 degrees, and the transition at the fore end has pitches less than 4 degrees, (ii) the lift path surface's median width is greater than one ninth the aircraft's maximum width, (iii) the lift path surface's median width is between than eight tenths and twelve tenths the payload compartment's median maximum width, (iv) the lift path surface's median length is greater than seven tenths the payload compartment's median length, (v) greater than one fourth of the total lift path's surface area is comprised of lift-stabilizing surface areas, (vi) greater than two thirds of the total lift path surface areas are comprised of high-lift-to-drag-capturing surface areas, and (vii) the pitch reference plane is the plane of tangency on the lift path at the lift path's closest point to the aircraft's center of gravity.

Preferably the lift-stabilizing surface area behind the center of gravity is between 53% and 70% of the total high-lift-to-drag-capturing surface area.

Optionally, there are fences on both sides of the lift path surface wherein the fence has a vertical extension between 2% and 20% of the lift path's median width and an outward horizontal extension between 0% and 20% of the lift path's median width. Preferably the lift path's surface connects smoothly and continuously with a wing's surface and the fence's vertical extension goes to zero at a region by the wing's surface.

Optionally, there is a platform on each side of the fuselage, each said platform having a vertical thickness between 1% and 20% of the lift path's median width, a width between 1% and 70% of the lift path's median width, a length between 30% and 100% of the lift path's median length; wherein, the lift path's surface connects smoothly and continuously with a platform surface and the fence's vertical extension goes to zero at a region by the platform's surface.

Optionally, there is a cabin walk-path vertical extension of the lift path surface said extension expanding a portion of the lift path surface away from the payload compartment wherein said expansion has a width between one and four feet.

Optionally, there is an upper lift path surface wherein said upper lift path surface is a lift path surface on the top of the fuselage. Optionally, there is a pressure-reducing canopy having a continuous and smooth surface connection to the fore end of the upper lift path surface wherein: said pressure reducing canopy having a median slant between −4 and 4 degrees, a forward pitch of less than −10 degrees, a continuous mid-section pitch reaching a peak height at a zero degree pitch, a starboard side, a port side, a width extending from the lift path port side to the lift path starboard side, and a smooth surface connection to upper lift path surface. Optionally, there are fences on both sides of the pressure reducing canopy wherein the fences have equal vertical extensions between 2% and 20% of the lift path's median width and an outward horizontal extension between 0% and 20% of the lift path's median width Optionally, there is an upper rear wing said upper rear wing having an upper surface and a lower surface wherein the lift path's surface connects smoothly and continuously with the upper rear wing's upper surface.

Optionally, there is a lower lift path surface wherein said lower lift path surface is a lift path surface on the bottom of the fuselage. Optionally, there is a pressure-generating surface having a continuous and smooth surface connection to the lower lift path surface wherein: said pressure generating surface having a median pitch between 50 and 20 degrees on the front of the fuselage, a median slant between −4 and 4 degrees, and a continuous decrease in surface pitch until the smooth and continuous connection with the lower lift path surface. Optionally, there are fences on both sides of the pressure-generating surface wherein the fences have equal vertical extensions between 2% and 20% of the lift path's median width and an outward horizontal extension between 0% and 20% of the lift path's median width. Optionally, there is an upper rear wing said lower rear wing having an upper surface and a lower surface wherein the lift path's surface connects smoothly and continuously with the lower rear wing's lower surface.

Optionally, there is an upper rear wing, a lower rear wing, and fuselage sides, wherein the distance between the fuselage sides decreases to a vertical edge between the upper rear wing and the lower rear wing.

Optionally, there is one or more rear wings where the rear wing is a swept wing.

Optionally, there is a wing, an energy storage means, and a propulsion means wherein the wing has a wingspan greater than three times the median maximum payload compartment width.

Optionally, there is a tether wherein the aircraft is a tethered glider and the tether pulls the aircraft along a guideway.

Optionally the aircraft is in supersonic flights and wherein a Liftpath is on the upper surface of the fuselage.

Optionally, there is a rudder at the feed or discharge of a rear propeller wherein the rudder in a state of hovering flight.

Alternatively, the lift path surface embodiment is an embodiment of lift path surface sections, where: (d) a plurality of lift path surface sections extending longitudinally on the fuselage having: a median width, a median length, a cumulative surface area of all lift path sections, fore ends, aft ends, port edges, starboard edges, and a lift path section of closest approach the aircraft's center of gravity. Here the limits on “surface's” of the preferred embodiment apply to the “surface sections's”.

An alternative design is a wide-body configuration. For flight at lower pressures (e.g. 0.2 atm), the fuselage cross section of FIG. 22 has distinct advantages to further increase L:D and have costs comparable to tubular designs. The FIG. 22 design is a wide body with seating in the middle and both sides and two walkways 147. Additions (sharper corners) to build up the sides of the upper and lower platforms are a good option (with fences) and are illustrated in the left option versus the right option. Example seating is 5 across in the middle, and 3 across on both sides. Within the cabin, cables, trusses or other devices 148 may connect the upper surface to the lower surface for structural support. Those supports 148 are preferably intermittent.

Enhanced Molded Induction Welder

High temperature electromagnets can be made by using liquid or muds that form solids that can withstand high temperatures, solids such as ceramics and porcelain. Bare, rather than insulated wires can be used if the solid-forming material is non-conducting.

Electromagnetic coils encased in high-temperature housing may be used to weld materials using a system having two electromagnetic functions. A first coil (electromagnetic) holds ferromagnetic materials in place using magnetic forces, for example, with a direct current energizing. A second coil performs induction heating to melt the metals of two sheets or a binding metal between sheets. In the absence of moving the coils, it is a spot welder or spot brazer.

The first coil(s) pulls, holds, and secures the ferromagnetic materials against the welder surface. Preferably, the coils in the welder are cooled using a passive cooling fluid with a natural convection loop. For brazing, the melting binder may be placed between the metals, optionally in grooves (or space between metals) prior to initiating the welding process. The second coil may be physically inside the first coil.

Methods used to make electromagnet devices may be used make devices in polymer matrices having higher metal contents than otherwise possible with flowing mixtures. A fully-wetted mixture of solid particles in a fluid has generally poor flow characteristics (for injecting or pouring into a mold) at concentrations greater than 50% by volume solids. However, it is desirable to have higher contents of said solids in the final molded product. This embodiment is a method for concentrating (typically metal) solids at solid concentrations greater than 70% by volume. The solids are concentrated in a continuous second solid phase starting with mixing the solid particles is a solid-forming liquid to form wetted-surface solids.

For purposes of this document, magnetic particle (or magnetic material) are solid particles that interact with magnetic fields and include: a) ferromagnetic particles (or ferro-particles) defined as particles that are strongly attracted to constant magnetic fields, b) diamagnetic particles defined as particles that are repelled from changing magnetic fields, and c) paramagnetic particles defined as particles weakly attracted to magnetic fields. By example, a preferred “changing magnetic field” is a field changing polarity at a rate greater than 1 Hz, preferably between 60 and 6,000 Hz, and most preferably between 500 and 1500 Hz.

A method for fabricating a molded device is comprised of placing a plurality of solid magnetic particles in a mold, placing a solid-forming liquid in the mold said solid-forming liquid forming a mixture with the magnetic particles said mixture having of an overall volume fraction between 0.1 to 0.7 magnetic particles, and applying a non-uniform magnetic field to the mold. In this method, the magnetic particles move with an increase in concentration of particles at a first region in the mold and a decrease in concentration of particles at a second region in the mold, the volume fraction of solid-forming liquid in the first region decreases to less than eight tenths the overall solid-forming liquid volume fraction in the mixture, and the solid-forming liquid forms a solid.

Preferably, the first region has a magnetic field strength between 0.2 and 3.0 Tesla and the second region has a field strength less than eight tenths the field strength of the first region. The solid-forming liquid may be a mud mixture and the solid product a ceramic. Preferably, at least half the particles have a maximum dimension between 0.01 and 0.5 mm, and at least part of the mold is located in the inner core of an electromagnet coil. As with earlier embodiments, an electromagnet coil may be in the mold where the coil generates a magnetic field during the method.

The method may use ferromagnetic particles in the mixture that are attracted to volumes of higher magnetic strength. The method may permanently magnetize particles by applying a magnetic flux greater than 0.5 Tesla to the mold. Alternatively, the method may use diamagnetic particles in the mixture wherein said particles are repelled by volumes having higher time-averaged absolute magnetic fields of alternating polarity. Here, the term “absolute” refers to the averaging method such that negative and positive field strengths both add positively to the absolute average.

To form casts of overall higher metal content, a mixture containing less than 0.6 volume fraction magnetic particles may be removed from the mold prior to setting of the solid-forming liquid; this is possible after some of the particles concentrate at the first region. The drained mixture may be mixed with more solid particles and promptly used in a subsequent molding process to reduce waste.

As the packing of solid particles approaches the maximum packing density due to the magnetic field forces; compressive forces may be applied to the mold (e.g. a press) to further increase density. Lower pressures are needed in this pressing process than for pressing processes that are not performed with a continuous liquid phase around the magnetic particles. Examples pressing forces are 50 to 5,000 pounds per inch squared.

In this method, preferably: the magnetic field strength is between 0.02 and 3 Tesla in the mold, particles are concentrated in at least some locations of the mold to concentrations greater than 70% by volume; and more preferably greater than 80% by volume, at least half the particles have a maximum dimension between 0.001 and 4 mm; more preferably between 0.01 and 0.5 mm, at least part of the mold is located in the inner core of an electromagnet, at least part of the electromagnetic field is generated by an electromagnet located below the mold, ferromagnetic particles are attracted to the first location in the mold by magnetic field strengths higher than the average magnetic field strength in the mold wherein ferrite particles is an example of ferromagnetic particles.

An alternating polarity the magnetic field exerts a repulsive force on the particles and the first location is a location of a time-averaged magnetic field strength less than the average time-averaged magnetic field strength in the mold. Here, the particles are diamagnetic. Example such particles are aluminum, copper, and carbon nanotubes.

Generally, the particles concentrate to form a permanent magnet where permanent magnetism is generated by applying a magnetic field greater than 0.5 Tesla to the cast after some of the particles have moved the first location. Note that magnetic particles prior to pouring in the mold would result in a mixture that does not readily flow.

Particles are attracted to (or repulsed to) a side of a polymer plate for film, forming a film with one side having a high metal content; wherein the side with the high metal content is buffed to provide a metal-like surface. Here, the cast volume is a layer on a conveyer belt.

Particles may be covered with a metal coating having a lower melting point than the bulk of the particle and wherein the highly-concentrated solid metal product is heated to a temperature sufficient to cause sintering of the magnetic particles to a sintered body structure and wherein the solid-forming liquid is able to release gases through its porous network (such as clay nanoparticles in a water solution).

Devices

Devices made by this method are comprised of an exterior wall and an electromagnet coil, and a continuous non-metal phase said non-metal phase surrounding a plurality of magnetic particles having saturation fluxes greater than 0.5 Tesla. The non-metal phase and magnetic particles form a solid composite said composite have a plurality of regions of different average densities, wherein a first region of highest average density forms an inner electromagnet core, a second region of lower average density adjacent to the coil and outside the coil, and a third region of lowest average density outside the coil and further distant from the coil than the second region, and as a result, the second region (at least in part) comprises magnetic particles having saturation fluxes between 0.5 and 2.5 Tesla with maximum dimensions less than 1 mm surrounded by a continuous non-metal phase having a saturation flux less than 0.4 Tesla.

Preferably, the third region of the device is of lowest average density; forming the outer wall of the electromagnetic device. The device may include a cooling fluid duct passing through windings of the coil.

A joint of controlled flexibility may be made using this method comprising a flexible electromagnet core said core having discrete ferromagnetic sections separated by flexible sections along a longitudinal dimension of the core, and a coil surrounding the flexible electromagnetic core. Increased current in the coil induces increased longitudinal attractive forces of the discrete ferromagnetic sections resulting in greater resistance to core flexibility in at least one direction perpendicular to the longitudinal axis of the core.

The joint preferably includes a polymer foam as part of the flexible core; flexible foam allows for volume changes at locations in the foam that increases flexibility and decreases destructive erosion. Preferably, the end-to-end adjacent ferromagnetic sections have matching male and female geometries where the male geometry is of a shape between that of a ball and a cone.

Optionally, the device has a cooling cavity located between coil wires said cavity comprising a volume of fluid, an entry port, and an exit port where wherein a fluid flows through the entry port, volume, and exit port; and said fluid removes heat from the coil wires. Preferably, the device includes a cooling heat transfer surface as an outer body surface wherein ducts for flow of the fluid contact the outer heat transfer surface, and the cooling fluid undergoes evaporation between the coil wires and condensation next to the outer surface and wherein at least one duct along the outer heat transfer surfaces connects the entry port to the exit port.

A film or body surface may be made using this method where one side is metal in nature. The resulting device of claim 11 is a sheet of less than 10 mm thickness wherein the first region is on a first face of the sheet.

This fabrication method is particularly useful for making more-complex electromagnetic devices such as a functional rotor. In this embodiment the term “functional rotor” is used to refer to a rotating device that is both the rotor of a rotary motor (or generator) and a functioning rotating device (without an axel) such as a vehicle's wheel, a centrifugal pump, a wind turbine, a regenerative brake, a grinder (e.g. garbage disposal), or a pulley (non-inclusive list).

A molded functional electromagnetic device is comprised if a rotor, a center axis of rotation, and multiple electromagnet coils connected in an electrical circuit wherein a current in one coil produces a current in other coils in the rotor. Preferably, the coils are comprised of less than three loops of conductive wire, the coils are coated with an insulator, a mixture of diamagnetic particles and a non-metal continuous phase surround the coils forming at least one surface symmetric with the center axis of rotation, and a first region of higher average mixture density is at the radius of the coils and a second region of lower average density is at a different radial region. For coils in this rotor embodiment; the coil embodiments do not include connection of coils to a power supply.

Specific devices formed when the the rotor is attached to a stator include such things as pumps, grinders, propulsion wheels, regenerative brakes, and wind turbines with generators

Devices including a functional rotor are comprised of an axis of rotation, multiple electromagnet coils connected in an electrical circuit wherein a current in one coil produces a current in other coils in the rotor, a surface within 2 mm of the coils said surface symmetric to the axis of rotation. Preferably, the coils are comprised of less than three loops of conductive wire, the coils are coated with an insulator, a mixture of diamagnetic particles and a non-metal continuous phase surround the coils forming at least one surface symmetric with the center axis of rotation, and a first region of higher average mixture density is adjacent to the surface and a second region of lower average density greater than 5 mm distant from said surface.

Preferably, the functional rotor is comprised of a rotary functional device and an electrically conductive surface of rotation said surface having a clearance of 0.1 and 20 mm between the surface and the multiple stator coils the stator induces electrical current in the conductive surface and the rotary functional device performs an operation of at least one function from the list: pumping, wheel-based propulsion, converting fluid velocity to rotary motion, generating electricity, grinding, brushing/sweeping, braking (reverse of propulsion), or providing a location of pulley rotation.

Optionally, the rotating part is comprised of a multiple electromagnet coils connected ins an electrical circuit wherein a current in one coil produces a current in other (possible all) coils in the rotating part (coils are spaced in clearance to stator), the rotating coils pass at a clearance of 0.1 to 20 mm of the stationary coils, one stationary coil generates a primary magnetic field, that primary magnetic field generates a current in a coil of a rotor coil passing through the primary field wherein that current directly or indirectly (voltage if parallel connections, current if connections in series) results in current in other coils of the rotor, and the magnetic field generated by the rotor's coils passes through coils of the stator said field generating a current in the stator's coils said current directed to a useful circuit or storage device. Here, the rotor is comprised of inter-connected coils that can be configured linearly as a linear motor and the device is a linear regenerative brake.

Flat devices have useful application where the stator has a maximum radial dimension that is at least twice the stator's maximum axial dimension and the device has a maximum radial dimension that is at least twice the device's maximum axial dimension. Example devices include a flat pump, a flat grinder, and a flat garbage disposal unit. Here the term “flat” refers to a general appearance of short height relative to width/radius. Examples of greater specification include: a stator that is radially outside the rotor (such as in a grinder), a stator that is radially inside the rotor (such as a wheel on a vehicle), an annular stator that fits in an annular rotor at least partially within an annular groove in the rotor (groove along inner radius or groove along outer radius) wherein motor is applied for vehicle propulsion. Optionally, a wheel's rotor is comprised of multiple rotor rings that can slip relative to each other and relative to the stator (to absorb bumps, a shock absorber).

A preferred embodiment for a wheel comprises one or more washer-shaped rotors 149 with flat sides 150 of the rotors engaging adjacent stator surfaces at clearances of between 0.1 and 20 mm (more preferably 0.2 to 3 mm). The outer radial surface of the rotors comprise traction surfaces 151 common of polymer, like rubber, common in the industry for tires; the traction surface are optionally wider (axial direction) than the clearance surface region of the rotor.

The washer-shaped rotors comprise diamagnetic material that is repelled with angular acceleration by the adjacent stator surfaces and optionally contain connected inductive coils consistent with previously described embodiments capable of regenerative braking. Said diamagnetic material is balanced with respect to a center of rotation 152 of the rotor and arranged to provide stable rotation around the center of rotation through interaction with power circuit coils in the adjacent stator. Said power circuit coils are also radially align to provide a stable rotation of the coils. Stability of the rotor rotation may be supplemented by diametric material in the rotor either inside or outside (but preferably not both) the radii range of the power circuit coils. In this configuration, the absence of barriers to radial movement of the rotor allows the rotor to temporarily move in response to bumps in the road where the wheel travels.

A series of multiple parallel rotors operating with the same center of rotation allows small obstacles in the path of travel to only bump some of the rotors; thereby allowing a smooth ride for the vehicle. Optionally, the rotor is comprised of a flexible polymer continuous phase that supports diamagnetic particles in a manner that allows radial flexibility in rotor to assist with dampening bumps. Example flexible polymers are rubber and urethane foam.

The approach of molding coils (powered or inductive) in a flexible polymer matrix has applications beyond the wheel embodiment; especially for damping the impact of bumps in the path of travel and avoiding the collision of clearance surfaces.

An MRI or NMR machine is another category of molded devices possible with the embodiments of this invention. These are comprised of a central tube of high magnetic flux, at least one pair of toroidal coils located at opposite ends of the tube where (optionally) a core connects the two coils said core outside the volume of the tube, a helical coil surrounds the core (for purpose of reducing leakage of magnetic flux), high-Tesla material is in inner cores of coils at ends of tube, a helical coil surrounds tube reducing leakage from tube, a conductor of fine conductive magnetic particles surrounds the tube to direct magnetic fields and reduce leakage, and the toroidal coils are not limited to circular toroid shapes.

### Illustrative Example 1—Analysis of Induction Generator Embodiment

In this example, the axial, radial, and angular dimensions are relative to the center of rotation of the induction generator's rotor.

Nine toroidal rotor coils with radially oriented poles at 20 and 22 cm R (rotor radius) have inner cores of pi/9 radians; the rotor coils are equally angularly spaced; outer cores direct the magnetic fields radially inward and axially outward from the coil poles with minimal angular orientation of the magnetic fields, and.

A DC-powered coil/magnet of similar dimensions to the rotor coils and radially-oriented poles from 22.5 cm and 24.5 cm R is connected to the stator wherein during rotation the DC-powered coil it exhibits regular pole-to-pole alignment with the rotor's nine electromagnets.

During rotation, a circuit of the rotor coils exhibits a current that cycles at pi/4.5 radians (at 600 rpm, the cycle is at 80 Hz).

Any stator toroidal coil of orientation having a pole at about 22.5 cm R, an inner core/pole of less than pi/8 radians, and significant pole-to-pole (temporal) orientation with the rotor's coils would undergo a changing flux at 80 Hz as a result of each rotor coils that is connected in series or parallel with a rotor's coil activated by the DC-powered coil/magnet.

The current may be harvested at a voltage based on coil geometries and efficiencies; the harvested electricity may be stored or otherwise used. The rotor may be powered by an alternative source, in which case this device performs as an induction electrical generator. The rotor may be attached to a wheel on a vehicle, in which case the this device performs as an induction regenerative brake.

Preferably all coils in the rotor are connected such that an induced current in one coil results in current in all coils. The rotor's coils may be connected in series. The rotor's coils may be connected in parallel. Preferably, the stator has the same number of coils as the rotor of equal spacing and similar sizes with regular pole-to-pole orientation with the rotor's coils during rotation. Preferably, the coils of the stator may be energized to perform as an induction motor. Preferably, circuitry allows at least one of the coils of the stator to be separated from the circuit and powered with DC current to switch from operation as a motor to operation as a regenerative brake.

Preferably the coils of the rotor are of thick wire with low resistance to flow; possibly with each toroidal is a coil of one turn (or slightly over one turn). This high-diameter wire may be formed from bare wire that is subsequently coated with insulation; this high-diameter wire may be 3D printed; this high-diameter wire may be cast in a mold; this high-diameter wire is not limited to cylindrical shape; additional material may be cast around this high-diameter wire.

Alternatively, coil and pole orientations similar to those commonly used in electric motors may be used while preserving the connections, induction, and DC power of this example.

Alternative to the DC-powered coil, a permanent magnet may be used on the stator.

### Illustrative Example 2—Inductance of Toroidal Coil with Self-Assembled Core

A toroidal coil at 300 turns of 30 AWG insulated wire has an ID of about 14 mm and axial thickness of about 8 mm. The naked coils exhibits 1.44 mH inductance. The coil was placed in a container of iron filings and powered at 18 V (DC), removed from container, and placed in a shell to preserve the overall shape of the filings attached to the coil as the 18 V (DC) current is maintained; this toroidal coil with self-assembled core of 67 g exhibited 5.83 mH of inductance. The same naked coil was placed in a container and 67 g of iron filings were poured over the coil; this coil with piled core exhibited 4.2 mH inductance. This example illustrates how a self-assembled core produced improved performance relative to a poured (random) core.

1. A method for fabricating a molded device comprising:
placing a plurality of magnetic particles in a mold,
placing a solid-forming liquid in the mold said solid-forming liquid forming a mixture with the magnetic particles said mixture having of an overall volume fraction of metal between 0.1 to 0.7,
applying a non-uniform magnetic field to the mold,
wherein the magnetic particles move to increase concentration of particles at a first region in the mold and decrease concentration of particles at a second region in the mold,
wherein the volume fraction of solid-forming liquid in the first region decreases to less than eight tenths the overall solid-forming liquid volume fraction in the mixture, and wherein the solid-forming liquid forms a solid.

2. The method of claim 1 wherein the first region has a magnetic field strength between 0.2 and 3.0 Tesla and the second region has a field strength less than eight tenths the field strength of the first region.

3. The method of claim 1 wherein the solid-forming liquid is a mud mixture and the solid is a ceramic.

4. The method of claim 1 wherein at least half the particles have a maximum dimension between 0.01 and 0.5 mm.

5. The method of claim 1 wherein at least part of the mold is located in the inner core of an electromagnet coil.

6. The method of claim 1 comprising an electromagnet coil in the mold wherein the coil generates a magnetic field during the method.

7. The method of claim 1 comprising ferromagnetic particles in the mixture.

8. The method of claim 1 comprising diamagnetic particles in the mixture wherein said particles being repelled toward regions with lower relative time-averaged absolute magnetic fields of alternating polarity.

9. The method of claim 1 wherein a magnetic flux greater than 0.5 Tesla is applied to the mold and wherein the method casts a permanent magnet.

10. The method of claim 1 wherein a mixture containing less than 0.6 volume fraction magnetic particles is removed from the mold prior to setting of the solid-forming liquid.

11. A molded electromagnetic device comprising
an exterior wall
an electromagnet coil,
a continuous non-metal phase said non-metal phase surrounding a plurality of ferromagnetic particles having saturation fluxes greater than 0.5 Tesla,
wherein the non-metal phase and ferromagnetic particles form a solid composite said composite having a plurality of regions of different average densities,
wherein a first region of highest average density forms an inner electromagnet core, a second region of lower average density adjacent to the coil and outside the coil, and a third region of lowest average density outside the coil and further distant from the coil than the second region, and
wherein the second region comprises ferromagnetic particles having saturation fluxes between 0.5 and 2.5 Tesla said particles having maximum dimensions less than 1 mm and said particles surrounded by a continuous non-metal phase having a saturation flux less than 0.4 Tesla.

12. The device of claim 11 wherein the third region of lowest average density forms the outer wall of the electromagnetic device.

13. The device of claim 11 wherein said electromagnetic device comprises a cooling fluid duct passing through windings of the coil.

14. The device of claim 11 where the device is a joint having controlled flexibility comprising
a flexible electromagnet core said core having discrete paramagnetic sections separated by flexible sections along a longitudinal dimension of the core,
a coil surrounding the flexible electromagnetic core,
and whereby increased current in the coil induces increased longitudinal attractive forces of the discrete paramagnetic sections resulting in greater resistance to core flexibility in at least one direction perpendicular to the longitudinal axis of the core.

15. The joint of claim 14 comprising a polymer foam as part of the flexible core.

16. The joint of claim 14 where the end-to-end adjacent paramagnetic sections have matching male and female geometries where the male geometry is of a shape between that of a ball and a cone.

17. The device of claim 11 comprising
a cooling fluid cavity located between coil wires said cavity comprising a volume of fluid, an entry port, and an exit port,
wherein a fluid flows through the entry port, volume, and exit port,
wherein said fluid removes heat from the coil wires.

18. The device of claim 17 comprising a cooling heat transfer surface as an outer body surface
wherein ducts for flow of the fluid contact the outer heat transfer surface,
wherein the cooling fluid undergoes evaporation between the coil wires and condensation next to the outer surface,
and wherein at least one duct along the outer heat transfer surfaces connects the entry port to the exit port.

19. (canceled)

20. A molded functional electromagnetic device comprising
a rotor,
an axis of rotation,
said rotor comprising multiple electromagnet coils connected in an electrical circuit wherein a current in one coil produces a current in other coils,
a surface within 2 mm of the coils said surface symmetric to the axis of rotation,
wherein the coils are comprised of less than three loops of conductive wire,
wherein the coils are coated with an insulator,
wherein a mixture of electrically-conductive non-magnetic particles and a non-metal continuous phase surround the coils forming at least one surface symmetric with the center axis of rotation, and
wherein a first region of higher average mixture density is adjacent to the surface and a second region of lower average density greater than 5 mm distant from said surface.

21. The device of claim 19 wherein
the rotor is adjacent to a stator
the rotor is attached to a function device from the list comprising a pump, a grinder, a wheel, a regenerative brake, and a wind turbine with generator.
